(19) United States
(12) Patent Application Publication
(10) Pub. No.: US 2002/0133374 A1
(43) Pub. Date: Sep. 19, 2002

(54) System and method for facilitating services

(76) Inventors: Anthony Angelo Agoni, Laguna Hills, CA (US); Joseph M. Hoats, Rancho Palos Verdes, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/808,421

(22) Filed: Mar. 13, 2001

(51) Int. Cl. G06F 17/60

(52) U.S. Cl. 705/2

(57) ABSTRACT

This application discloses systems and methods of facilitating communication between a service professional and a client. In one embodiment, a professional submits profile data to a service facilitator who makes the profile data available to prospective clients, and the professional agrees to use a service enhancing system to provide service to any client obtained. The professional may agree to provide payment for use of the service enhancing system, may agree not to charge the client for the use of such system, may agree to use an enhanced version of the service enhancing system in exchange for enhanced availability of the profile data, may agree to specific standards of service in exchange for making the profile data available, and/or may agree to provide periodic assurance of adherence to the specific standards, or may provide a combination of those agreements.

### BACKGROUND OF THE INVENTION

1. Field of the Invention

This invention relates to facilitating interaction between a service professional and a client, including, in particular, pre-service searching and interviewing, service contracting, service delivery tools, correspondence management, standards compliance checking, service status review and update, billing, and data archival.

2. Description of the Related Art

Many service professionals face ongoing frustration in attempting to locate clients. Advertising dollars routinely fail to communicate the right characteristics of the right professional to the right client at the right time.

Some professionals even face industry-erected constraints against obtaining clients. For example, industry-imposed ethical rules severely restrict attorneys as to the methods they may use to attract clients. Such constraints have, for decades, prevented focused research and innovation in important aspects of the professional business sector.

Prospective clients also face obstacles. There is rarely sufficient time to conduct face-to-face interviews of the often large numbers of professionals advertising en masse in printed publications such as telephone directories, newspapers or trade journals. Moreover, those publications list only the most general information, making it virtually impossible for a prospective client to determine whether any of the listed professionals has particular skills or experience suitable for the client's personal circumstances. Furthermore, prospective clients can often learn little about each professional's competence, prior track record or approval rating among prior clients or among peers.

Once the client decides to contact a professional and inquire about hiring him or her, the client typically meets the professional and, after an interview of sorts, quickly comes face-to-face with the decision of whether to retain the professional. Rather than go through the same effort over and over again to compare one professional against another and against another, the client simply retains the professional despite anxiety and uncertainty.

When a client finally does retain a service professional to provide some service, the client often remains uninformed about the competence of the professional as well as the status of the specific service being performed. Some projects require a service professional to work on the case over a long period of time with neither concrete results to present to the client nor any perceived substantial need to communicate with the client. As just one example, after an injured client retains a personal injury attorney to obtain payment from an insurer, it may take many months or several years before the insurer pays. During this time, the attorney is working on the case, for example requesting and reviewing documents, contacting the insurer and negotiating with the insurer, and yet has no concrete result to present to the client. Since the attorney has received information and files from the client at the start, the attorney perceives no need to contact the client until the insurer has paid or has made some offer. As a result, even if the attorney is performing competent service, the attorney may neglect to communicate with the client for many weeks or months, and the client may feel neglected and frustrated. In fact, perhaps the most frequent complaint by clients against their attorneys is that attorneys do not adequately communicate with them. This problem also applies to other service professionals such as medical and dental professional, contractors, real estate agents, accountants and so forth, especially when matters become long and/or complex.

Once a professional begins working for a client, the client can do very little to ensure that, day-after-day, the professional is delivering service at a level acceptable within the standards of the particular industry. All too often, it is only long after the professional has “completed” the job that the client learns that the services rendered were below standard. Then, it is simply too late to obtain quality service. In many cases, clients never learn whether the professional they hired provided substandard services.

The recent popularity of and advancements in e-commerce have thus far failed to address or improve the above circumstances. Some professionals have put up sites describing their services on the World Wide Web (“web”). But such efforts fail to generate significant business for many reasons, such as that the web is not geography specific whereas the professional practice often is geography specific, that nothing objectively distinguishes or commends the professional as more appropriate than any other, and that the web site itself does nothing to enhance or improve the services provided.

Additionally, others have set up web sites or toll-free telephone systems purporting to help clients locate professionals, and vice-versa (e.g., 1-800-Dentists, 1-800-The-Law2, www.LawOffice.com, and www.FindLaw.com). Those efforts have often suffered from the same problems as the individual web sites established by professionals. In addition, the web site often focuses on the entire profession, rather than just a focused subset of that profession. Thus, the information provided either to clients or to professionals who attempt to use such web sites is too superficial to be really helpful. In many cases, the web site provider is not really interested in assisting prospective clients or professionals, but rather seeks only to generate “hits” to attract advertising revenue, distracting these web site providers from focusing research and development upon processes truly helpful to clients and professionals. In other cases, the web site provider, or telephone system operator, seeks merely to generate new business leads for a professional, who often pays to be listed on that web site, without regard for whether it is in the best interest of the client to use that professional. In addition, the web site or toll-free telephone system has nothing which inherently makes it in the client's best interest to choose a professional through that particular web site or telephone system rather than through similar, competing businesses. Providing little real incentive or benefit to prospective clients, and not being able to truly distinguish themselves from competing businesses in the eyes of the professionals, the existing web sites and telephone systems suffer from serious deficiencies.

It has been generally recognized that facilitating technologies offered by third parties should provide incentive for many customers and merchants to use those technologies. Accordingly, expectations of the participants must be high and they must be met by the provider of the facilitating technology to earn the ongoing trust of the participants. What is needed is a system and method comprising facilitating technologies and access thereto for the professional sector, which satisfy expectations of clients and professionals, earn the trust of both, and genuinely improve and enhance the quality of service rendered by the professional and received by the client.

### SUMMARY OF THE INVENTION

One embodiment of the present invention is a method of facilitating services. The method comprises: (1) generating listing information identifying a service provider; (2) making the listing information available to potential clients of the service provider; and (3) receiving an agreement from the service provider to use a first service-enhancing system to provide services to each client obtained as a result of the making the listing information available. An aspect of the method further comprises (1) generating second listing information identifying a second service provider; (2) receiving an agreement from the second service provider to use a second service-enhancing system having at least one feature absent from the first service-enhancing system; (3) making the second listing information available to at least some of the potential clients; and (4) enhancing the availability to the at least potential clients of the second listing information.

Another embodiment of the present invention is a method of facilitating services, in which the method comprises: (1) generating listing information identifying a service provider; (2) making the listing information available to potential clients of the service provider; and (3) receiving an agreement from the service provider to adhere to certain standards of care in providing services to each client obtained as a result of the making the listing information available, the certain standards being more specific, or higher, than those generally accepted or legally required to practice in the industry of the service provider. One aspect of the invention further comprises receiving an agreement from the service provider to use a computer software-based process to assure that the service provider adheres to the certain standards of care. A further aspect of the invention further comprises receiving a payment from the service provider for using the computer software-based process. A still further aspect of the invention further comprises receiving an agreement from the service provider not to pass on to any client any cost of using the computer software-based process.

An additional embodiment of the present invention is a method of facilitating services. The method comprises: (1) providing in a profile database profile data representing characteristics of a plurality of service providers, the profile data including identification data identifying each of the plurality of service providers; (2) receiving profile criteria and responsively searching the profile data for the profile criteria; (3) determining a portion of the profile data representing characteristics of a first of the plurality of service providers at least approximately match at least a portion of the profile criteria; (4) automatically generating a candidate selection prompt for a client to select the first service provider as a candidate for providing services to the client, the candidate selection prompt communicating a representation of the identification data identifying the first service provider; (5) receiving service summary information summarizing needed services and making the service summary information available to the first service provider; (6) automatically generating a prompt for the first service provider to agree to provide the needed services to the client; (7) providing a computer-based service module for use in providing services to the client or reporting the status of the services, the computer-based service module accessible by the client and the first service provider; and (8) receiving a payment from the first service provider. An aspect of the method is one wherein the first service provider is an attorney, and another aspect of the method is one wherein the payment is for use of the computer-based service module. A different aspect of the method is one wherein the computer-based service module automatically enforces certain standards that are more specific, or higher, than those generally accepted or legally required to practice in the industry of the first service provider. A further aspect of the method further comprises receiving acknowledgment data from the client, the acknowledgement data representing the client's understanding of (1) rules for using the computer-based service module, (2) consequences of untruthful or misleading information provided by the client, or (3) information provided by the client becoming a permanent part of a record of services, wherein the service summary information is made available to the first service provider only after the receiving of the acknowledgement. A still further aspect of the method further comprises receiving from the first service provider a password and responsively making available to the first service provider the service summary information and second service summary information summarizing second services needed. Further aspects of the method are those wherein the matched portion of the profile criteria includes data representing foreign language skills, wherein the matched portion of the profile criteria includes data representing an area serviced by the first service provider, wherein the matched portion of the profile criteria includes data representing experience of the first service provider, wherein the matched portion of the profile criteria includes data representing a keyword provided by the client, and/or wherein the computer-based service module facilitates and stores communications between the first service provider and the client. Another aspect of the method is one wherein the profile criteria include first and second profile criteria, and the method further comprises (1) assigning a first weight to the first profile criteria; and (2) assigning a second weight to the second profile criteria, the step of the determining performed by a computer after respectively applying the first and second weights to the first and second profile criteria. Still further aspects of the method are those further comprising: (1) communicating in the candidate selection prompt a representation of no more than a predetermined maximum number of service providers having associated profile data at least partially matching the profile criteria; or (2) communicating in the candidate selection prompt a representation of no less than a predetermined minimum number of service providers having associated profile data at least partially matching the profile criteria. Another aspect of the method is one wherein the profile criteria represent a geographic area, and the method further comprises: (1) communicating in the candidate selection prompt a representation of a first set of service providers for which a portion of the profile data represents a first area corresponding to the geographic area; and (2) communicating in the candidate selection prompt a representation of a second set of service providers for which a portion of the profile data represents a second area, the second area within a predetermined maximum distance from the first area.

A further embodiment of the present invention is status data representing past and current statuses of services rendered by a service provider. The status data comprising: (1) historic status data representing at least one non-current status of services rendered by a service provider, the historic status data accessible by a computer for read only viewing; and (2) current status data representing a current status of the services rendered by the service provider, the current status data accessible by a computer for read only viewing and accessible for a predetermined time for modification by the service provider, the predetermined time shorter than the time remaining to complete the rendering of the services.

Yet another embodiment of the present invention is status data representing past and current statuses of services rendered by a service provider. The status data comprises: (1) historic service data descriptive of services rendered or to be rendered by a service provider, the historic service data accessible by a computer for read only viewing; and (2) current service data descriptive of services rendered or to be rendered by the service provider, the current service data more recent than the historic service data, the current service data accessible by a computer for read only viewing and accessible for a predetermined time for modification by a client of the service provider, the predetermined time shorter than the time remaining to complete the rendering of the services.

A still further embodiment of the present invention is a service system facilitating the rendering of services. The service system comprises: (1) profile data representing characteristics of a plurality of service providers, the profile data stored on a first computer-readable medium; (2) a search engine responsive to search criteria to search the profile data for portions of the profile data at least approximately matching the search criteria and to generate result data identifying service providers corresponding to the at least approximately matched portions of the profile data, the result data formatted for presentation, the search engine comprising instructions executable by a processor; (3) a communication module making available to a client the result data, the communication module receiving candidate data representing a candidate set of service providers comprising one or more of the service providers identified by the result data, the communication module receiving and storing the service summary data representing needed services and making the service summary data available to each of the candidate set of service providers; (4) a case communication module receiving status data from a selected service provider selected from the candidate set of service providers, the status data representing a status of services provided by the selected service provider, the case communication module storing the status data and making the status data available to the client; and (5) a billing module generating a request for payment from the selected service provider. An aspect of the system is one wherein the payment is for use of the case communication module. Another aspect of the system is one wherein the search criteria include first and second profile criteria, and the service system further comprises: (1) a first importance level assigned to the first profile criteria; and (2) a second importance level assigned to the second profile criteria, the search engine configured to adjust the result data in accordance with the first and second importance levels. A further aspect of the system is one wherein the adjusted result data represent an ordered list of service providers, wherein a group of at least one of the service providers is represented at the front of the list, and wherein portions of the profile data representing characteristics of each of the at least one service providers in the group matches the first profile criteria. A further aspect of the system is one wherein the case communication module enforces certain standards that are more specific, or higher, than those generally accepted or legally required to practice in the industry of the service provider.

Another embodiment of the present invention is a computer-based services system. The system comprises: (1) a message archive storing on a first computer-readable medium message timing data representing a date and a time of at least one message sent from a service provider to a client or from a client to a service provider; (2) an update timer comprising instructions stored on a second computer-readable medium, the instructions executable by a processor to access the message timing data to determine a latest message time corresponding to the most recent of the at least one messages and to calculate a response time by comparing the latest message time and a current time; and (3) a message generator automatically generating a warning message when the response time is greater than a predetermined response time. One aspect of the system is one wherein the message generator automatically generates the warning message when fewer than a predetermined number of the at least one messages are dated later than a cut-off date, the cut-off date earlier than a current date by a predetermined number of days. Another aspect of the system is one wherein the predetermined response time is shorter than a maximum non-communication time representing a duration of non-communication between clients and service providers in the industry of the service providers longer than is generally accepted in the industry. A further aspect of the system further comprises an override time representing a period of time during which the message generator does not generate the warning message when the response time is greater than the predetermined response time. A still further aspect of the system further comprises confirmation data stored on the first computer-readable medium, the confirmation data representing an agreement by a client that the service provider need provide no communication or status update during the override time. Yet another aspect of the system further comprises (1) status update data stored in the message archive, the status update data representing at least one status update to inform the client about the status of services provided by the service provider, the message timing data representing a date and time of each of the at least one status update; and (2) a communication module responsive to a user request and to a change signal to permit the service provider to change a status update, the change signal generated by the update timer if a difference between a current time and a date and time associated with the status update is less than a predetermined change period. Another aspect of the system is one wherein the predetermined change period is twenty-four hours. Yet a further aspect of the system further comprises a communication module responsive to a user request and to a change signal to permit the client to change selected data in the message archive, the change signal generated by the update timer if a difference between a current time and a time associated with the selected data is less than a predetermined change period.

Still another embodiment of the present invention is a system for facilitating services. The system comprises (1) means for representing with computer-readable data characteristics of and identification of a service provider; (2) means for allowing potential clients to search the characteristics over a computer network and receive a representation of data identifying the service provider; and (3) means for receiving agreement from the service provider to use a communication-enhancing system to provide services to each client obtained via the means for allowing potential clients to search the characteristics.

Another embodiment of the present invention is a system for facilitating services. The system comprises: (1) means for representing with computer-readable data characteristics of and identification of a service provider; (2) means for allowing potential clients to search the characteristics over a computer network and receive a representation of data identifying the service provider; and (3) means for receiving a representation from the service provider that the service provider meets certain minimum experience requirements, the experience requirements being more specific, or higher, than those generally accepted or legally required to practice in the industry of the service provider.

A further embodiment of the present invention is a method of facilitating services. The method comprises: (1) a step for providing in a profile database profile data representing characteristics of a plurality of service providers, the profile data including identification data identifying each of the plurality of service providers; (2) a step for using profile criteria to search the profile data and at least approximately match at least a portion of the profile criteria to characteristics of a first of the plurality of service providers; (3) a step for communicating an intent of the client to hire the service provider to provide services to the client; (4) a step for providing a computer network-based service module for use in providing the services to the client or reporting the status of the services, the computer network-based service module accessible by the client and the service provider; and (5) a step for receiving an agreement from the service provider to use the computer-based service module in providing services to the client. An aspect of the method further comprises a step for providing an interface for communicating basic information to the client relating to the services, the interface comprising a graphic representation of an object relating to the services, regions of the graphic representation relating to corresponding parts of the object, the regions independently selectable to retrieve and present information to the client relating to the corresponding parts of the object. A further aspect of the method is one wherein the object is a human body, wherein the regions correspond to parts of the human body, wherein the regions are selectable to present information to the client about body part injuries or operations, and wherein the services relate to legal or medical industries.

### BRIEF DESCRIPTION OF DRAWINGS

FIG. 1 is a high-level block diagram illustrating a host having accessible communication modules and databases, the host facilitating communication and service transactions between a professional and a client through a network in accordance with one embodiment of the present invention;

FIG. 2 is a high-level block diagram illustrating transaction categories involving a client, an attorney, the ActiveLaw™ web site, and the CaseSmart environment for facilitating the retention and provision of attorney services in accordance with one embodiment of the present invention;

FIG. 3 is a flowchart illustrating a process of creating or updating an attorney profile in accordance with one embodiment of the present invention;

FIG. 4 is a flowchart illustrating one embodiment of a process of a client searching and selecting attorneys;

FIG. 5 is a flowchart illustrating one embodiment of a weighted search process using multiple weighted search conditions;

FIG. 6A and FIG. 6B illustrate examples of pseudo-code instructions for a weighted search process;

FIG. 7 illustrates one embodiment of a detailed case submission form;

FIG. 8 is a flowchart illustrating one embodiment of a general process for preretainer communication between the client and the candidate attorneys and for retaining and billing an attorney;

FIG. 9 is a flowchart illustrating one embodiment of a process of pre-retainer communication between the client and the candidate attorneys and of retaining an attorney;

FIG. 10 illustrates one example of a pre-retainer case page;

FIG. 11 illustrates one example of a lawcenter table;

FIG. 12 is a flowchart illustrating one embodiment of a case communication process between the client and the retained attorney and of a process of closing a case and rating an attorney;

FIG. 13 is a flowchart illustrating one embodiment of components of a case status update and notification process;

FIG. 14 illustrates one embodiment of a case status display and update interface;

FIG. 15 illustrates one example of a post-retainer case page;

FIG. 16 illustrates one example of an attorney profile table;

FIG. 17 illustrates one example of an attorney rating table;

FIG. 18 illustrates one example of an initial case table;

FIG. 19 illustrates one example of a detailed case table;

FIG. 20 illustrates one example of a case status table;

FIG. 21 illustrates examples of records in an embodiment of a case status code table;

FIG. 22 illustrates one example of a text message table;

FIG. 23 illustrates one embodiment of a case control panel;

FIG. 24 illustrates one embodiment of components of a rating information display screen;

FIG. 25 illustrates components in accordance with an embodiment of the present invention for facilitating professional services rendered by an attorney to a client; and

FIG. 26 illustrates one embodiment of a graphical interface for retrieving information about service subject matter.

### DETAILED DESCRIPTION

The present invention relates to a system and method for facilitating the rendering of professional services. The description herein discloses such system and method, particularly directed to facilitating professional services provided by an attorney to a client. It will be readily appreciated that the disclosed system and method are not limited to facilitating attorney-related services, but apply also to services of other professionals such as, for example, contractors, accountants and real estate agents. Nevertheless, for ease of description, the system and method are disclosed in the context of attorney professional services, and, in particular, those rendered to a client in connection with personal injury matters.

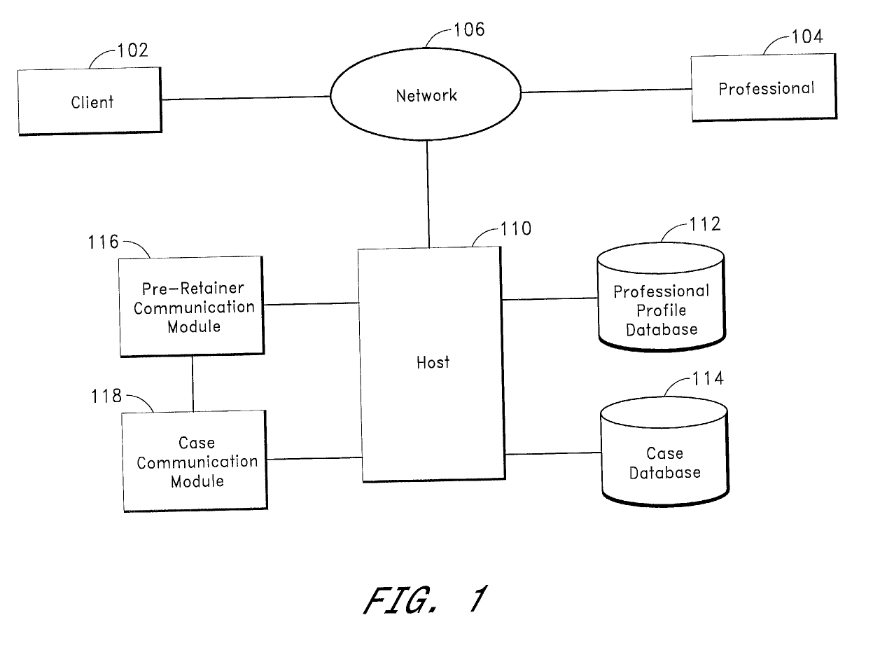

FIG. 1 is a high-level block diagram illustrating a host 110 having accessible communication modules and databases, facilitating communication and service transactions between a client 102 and a professional 104 through a network 106 in accordance with an embodiment of the present invention. The client 102, professional 104 and host 110 are connected to the network 106. In a preferred embodiment, the network 106 is the Internet, the host 110 is a web site server, and the professional 104 and the client 102 each use a web browser to connect to the host 110. The host 110 is connected to a professional profile database 112, a case database 114, a pre-retainer communication module 116 for managing pre-retainer communication between a client and candidate professionals, and a case communication module 118 for managing post-retainer communication between a client and a retained professional. Those ordinarily skilled in the art will appreciate that the professional profile database 112 and the case database 114 may be combined as one database, and that one universal communication module may be used to facilitate pre-retainer communication and post-retainer communication.

In a preferred embodiment, the host 110 and the client 102 and professional 104 each use a computer. The computer may be any general purpose computer, but preferably connectable to the Internet. The host 110 computer may, for example, comprise one or more Pentium III, Pentium IV, Athlon or other microprocessor(s) with 256 megabytes of RAM, controlling a 30 gigabyte hard drive and having a high-speed connection to the Internet through, for example, a network interface card. The computers for the client 102 and professional 104 may also comprise a Pentium III, Pentium IV, Athlon or other microprocessor, have 128 megabytes of RAM, multiple gigabytes of hard drive memory and may be desktop, laptop or notebook class computers with modem-based Internet connections. Alternatively, the computers for the client 102 and/or the professional 104 could be hand-held class computers with wireless connections to the Internet.

The host 110 facilitates communication between the professional 104 and the client 102 through the network 106. One embodiment of the host 110 is a web site server maintaining a web site referred to as the ActiveLaw™ web site, accessible via a domain name, such as, for example, www.activelaw.com, and hosting an application environment known as CaseSmart™, described in more detail below. For sending email messages to clients and professionals, CaseSmart™ interfaces with an email server running email service applications such as Novell Internet Message System and Microsoft Outlook.

In one embodiment, the web site runs on Microsoft Internet Information Server and Cold Fusion Server 4.5 in a Windows NT 4.0 operating system environment. Also, in that or another embodiment, CaseSmart's professional profile database 112 and case database 114 are managed using Microsoft SQL Server 7.0 under Windows NT 4.0.

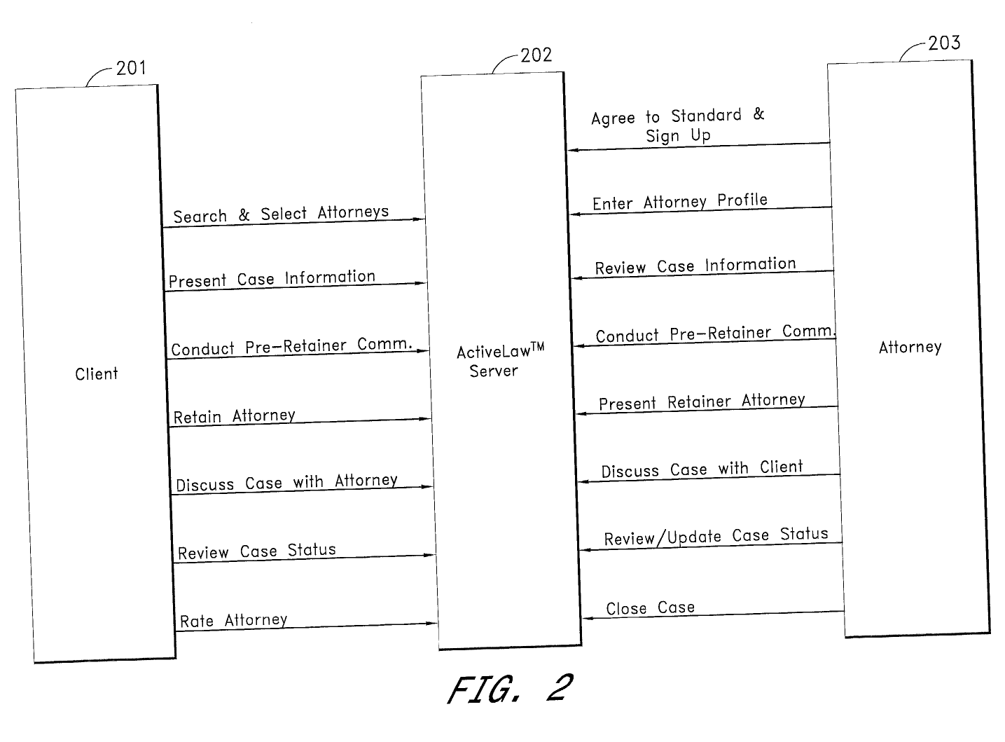

FIG. 2 is a high-level block diagram illustrating transaction categories involving a client 201, an attorney 203 and the ActiveLaw™ web site 202, in the CaseSmart environment for facilitating the retention and provision of attorney services in accordance with one embodiment of the present invention. The client 201 and the attorney 203 access the ActiveLaw™ web site 202 using a web browser such as Microsoft Internet Explorer or Netscape Communicator, or a wireless web browser. As will be appreciated by those of ordinary skill, the use of standard web browsers permits access to the ActiveLaw™ web site 202 from anywhere using any one of a growing number of web access platforms.

The web site 202 contains general information helpful to clients and attorneys, such as, for example, answers to frequently asked legal questions, recent court decisions, and so forth. Beyond accessing the ActiveLaw™ web site 202 to browse general information, an attorney 203 may decide to adopt ActiveLaw™ and the CaseSmart™ environment to play a much larger role in his or her professional practice, and thus become an ActiveLaw™ member attorney.

To become an ActiveLaw™ member, the attorney takes a few initial steps. First, the attorney agrees to provide a standard of service generally higher than that required to maintain his or her law license, and then signs up as an attorney member of the ActiveLaw™ web site 202. Next, the attorney 203 enters an attorney profile record on the web site 202. CaseSmart™ then stores the entered attorney profile in the attorney profile database 112 connected to the web site 202.

Prospective clients may also browse the ActiveLaw™ web site 202 for general and useful information. However, they may also use the ActiveLaw™ web site 202 as a single, one-stop reference tool for locating an attorney ideally suited to handle a particular, possibly urgent, legal matter. To effect such use, the client 201 accesses the ActiveLaw™ web site 202, selects an attorney search option, and enters detailed search conditions to search for attorneys with profile records matching the search conditions.

CaseSmart returns information indicating which attorneys matched the search conditions. The client 201 may select all or some of the attorneys and submit detailed case information to the selected candidate attorneys for review. CaseSmart stores the submitted detailed case information in the case database 114 connected to the web site 202. CaseSmart's pre-retainer communication module 116 facilitates and permits preretainer communications between the client 201 and the candidate attorneys regarding both the case and retainer terms.

When the client 201 is ready to retain an attorney, the attorney 203 electronically presents a retainer agreement to the client 201 for signature. The client 201 and the retained attorney 203 then use CaseSmart's case communication module 118 to discuss the case as it progresses through its various phases. The attorney 203 uses the case communication module 118 to update the status of the case, and both the attorney 203 and the client 201 use the module 118 to review the status of the case and to send messages to each other. The client further uses the case communication module 118 to rate the attorney 203 when the services have been rendered. When the case is resolved or otherwise terminated, the attorney 203 closes the case.

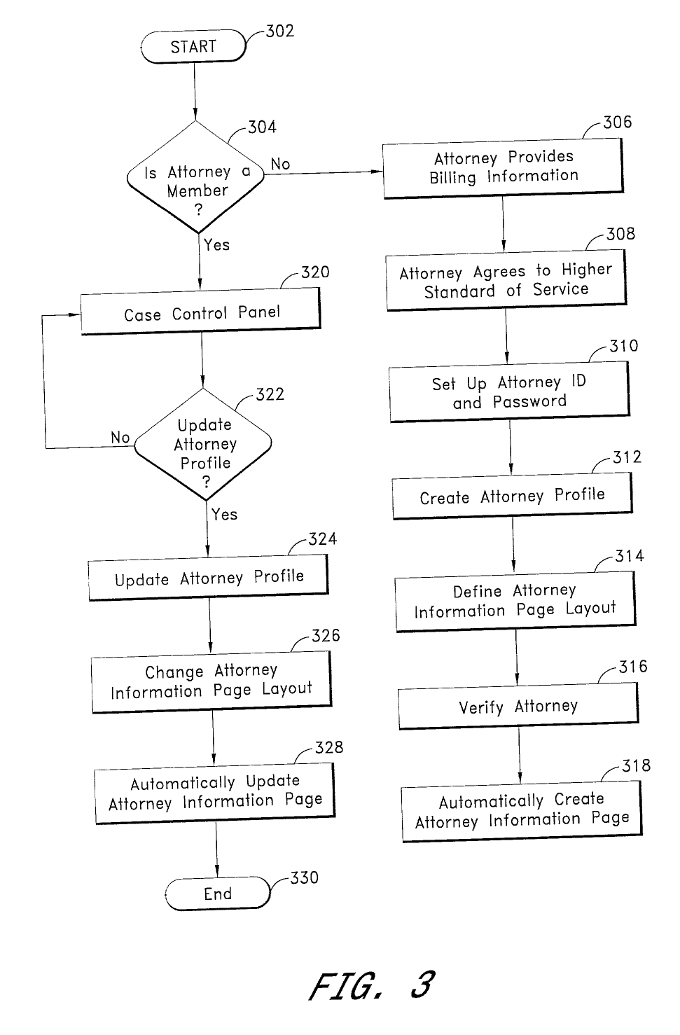

FIG. 3 is a flowchart illustrating one embodiment of the process of creating or updating the attorney profile record. That process is invoked when an attorney, preferably by accessing the ActiveLaw™ web site 202, selects a hyperlink labeled MEMBER. In one embodiment, an attorney may opt to have an ID and password stored in a cookie, or otherwise on the attorney's computer, and automatically detected by the ActiveLaw™ web site 202.

A start state at a block 302 proceeds to a block 304, where a determination is made as to whether an attorney is already a member of the ActiveLaw™ web site 202. In one embodiment, a validation module of CaseSmart checks an ID and password combination—either detected automatically or provided by the attorney—against stored ID and password combinations. If the attorney is not a member, or if the attorney selects an available option to sign up as a member (such as a hyperlink labeled SIGN UP AS MEMBER), a sign up web page is requested and presented to the attorney, which, at a block 306, requests that the attorney provide billing information such as a credit card number. The sign up web page also presents the attorney with the billing policy of the web site provider operating the ActiveLaw™ web site 202. In one embodiment, the sign up web page further requests that the attorney agree to be charged an initial fee in order to proceed. This practice may deter professionals who are not serious about joining as member attorneys.

At a next block 308, in one embodiment, the attorney is prompted to agree to a certain specific standards of service before being allowed to join as a member and before being provided full use of the CaseSmart environment to manage his or her cases. In one embodiment, the attorney is prompted to read a description of the specific standards online and prompted to click an “I Agree” button. The specific standards of service generally, but need not, exceed the standard of care generally acceptable or legally required to work or practice in a particular profession. In one embodiment, the specific standards of service include the requirement that the attorney communicate with the client and update the status of the case on a frequent basis, such as, for example, once each week until the client's case is closed. The attorney agrees to use CaseSmart in connection with any case taken via use of an ActiveLaw™ web site, agrees to be billed on a periodic basis for the use of CaseSmart, and agrees to use CaseSmart's communication module 118 for communication and updates in connection with each case. In an alternative embodiment, the attorney need not agree to use CaseSmart for all communications with the client, but the attorney does agree to adhere to the specific standards of service and to provide some evidence on a periodic basis that he or she is doing so. Thus, the attorney may agree to complete, certify and forward to an ActiveLaw administrator a form summarizing the content of communications and updates provided to the client indicating the date on which each summarized communication was made. The form may be an electronic form provided electronically, or a paper form. The ActiveLaw administrator uses the form to update the status of the attorney's communications with the client.

In a preferred embodiment, the attorney agrees to the specific standard that expenses related to the use of CaseSmart will not be charged to the client. Thus, the attorney is not reimbursed for his or her payments to use CaseSmart. Therefore, advantageously, clients do not pay extra (or receive smaller judgments) in exchange for greater assurance of a high quality of service.

In one embodiment, the attorney acknowledges that CaseSmart's case communication module 118 will monitor the frequency of communication between the attorney and the client, and will notify the web site provider, the client and the attorney when timely communication has not been made. The attorney further acknowledges that CaseSmart's case communication module 118 will provide a warning at a time prior to the deadline for communication to help ensure that communication does occur before the deadline. In addition, in one embodiment, the attorney agrees to a predetermined consequence arising when a threshold number of communication periods (e.g., 14 days each) have passed with no communication or case update and/or when a threshold number of communications has not been made in a predetermined time period. The predetermined consequence, in one embodiment, is that the attorney provides 40 hours (or some other number of hours) of pro bono work. In other embodiments, the predetermined consequence is a monetary fine payable to ActiveLaw, the client or a legal charity, or a report generated for and provided to the state bar indicating that the attorney has not upheld the service standard to which he or she agreed.

Agreements from professionals, such as, for example, attorneys, to adhere to specific standards of professional service, including frequency and forms of communication and status updating, advantageously enhance the level of service to clients, increase and satisfy client expectations, and quickly earn the trust of clients. In particular, the attorneys using an ActiveLaw™ web site 202 and the CaseSmart environment, by agreement, ensure that clients are never left wondering what is the status of their case, thus completely eliminating what is perhaps the most common and frequent complaint among legal clients—lack of communication. Thus, the ActiveLaw™ web site 202 and the CaseSmart environment raise and enhance the level of legal services provided by and for the attorney and client user base.

CaseSmart's case communication module 118 also provides for periods of time without communication. In one embodiment, CaseSmart provides for two vacation periods wherein the attorney need not communicate with the client or provide an update of the status of the case. The duration of the vacation periods are configurable, but may be three weeks, for example. By selecting an option button labeled “VACATION” available optionally on the attorney's case information web page, CaseSmart will prompt the attorney to confirm a date upon which a vacation will begin and a date upon which it will end, and then CaseSmart will automatically avoid communication monitoring during that period and will also automatically update the date of last communication to be the date on which the attorney's vacation ends.

In another embodiment, CaseSmart's case communication module 118 also provides for mutually agreed periods of time without communication. For example, if the attorney plans a three-week vacation, the attorney may so inform the client, and the two may agree that for a three-week period beginning on a certain day, the attorney will not communicate with the client or update the case status. In one embodiment, the case communication module 118 receives separate, independent requests from both attorney and client for a period of no communication. Both requests must be identical in terms of start date and end date. If the requests are successfully verified to be identical, then CaseSmart's case communication module 118 will automatically avoid communication monitoring as described above. In a preferred embodiment, both client and attorney, at separate times, select a hyperlink labeled NO COMMUNICATION PERIOD from a web page of the ActiveLaw™ web site 202 to request and effect a no communication time period.

At a further block 310, a web page having appropriate fields prompts an attorney to supply an ID and a password to access the web site 202 as a member. The attorney enters an ID and password combination and clicks a hyperlink command button labeled PROCEED. CaseSmart extracts the ID and password from the information returned to the web server of the ActiveLaw™ web site, and checks them for uniqueness, and stores them along with other information about the attorney in an attorney profile record created by CaseSmart.

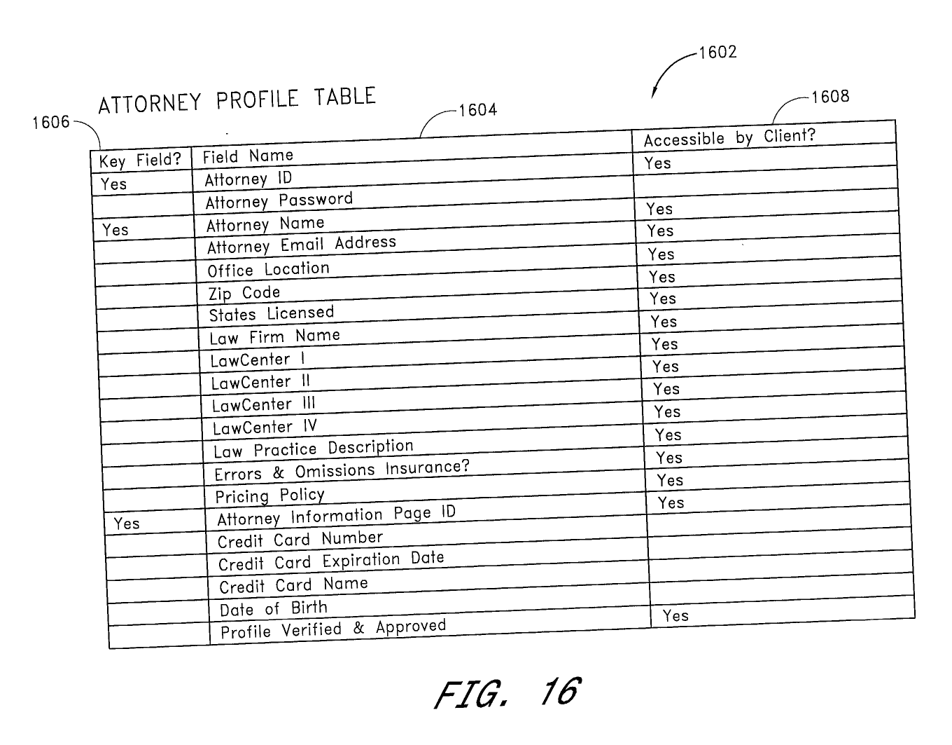

At another block 312, the attorney is similarly prompted to provide information in fields of a web page to create a detailed attorney profile record. An attorney's profile record may include the attorney's name and address, law firm affiliation, the number of years in practice, the languages that the attorney speaks, the languages that the office staff of the attorney speaks, the location of the attorney office, one or more zip codes corresponding to areas in which the attorney is available to practice, the states where the attorney is licensed to practice, state bar registration number, the practice sub-area(s) of the attorney (such as automobile accident cases or medical malpractice cases), the billing rates and pricing policy of the attorney, whether the attorney has errors and omissions insurance, a description about the attorney, and so forth. The practice sub-areas are called “LawCenters” in the ActiveLaw™ web site. The fields of the attorney profile record correspond to those of the attorney profile table, an example of which is illustrated in FIG. 16.

In one embodiment, the attorney is prompted to represent to an operator of an ActiveLaw web site 202 that the attorney meets certain standards. In one embodiment, the attorney represents (1) that he or she has litigated or settled a minimum threshold number of cases (e.g., four) in the area of law corresponding to one or more of the identified LawCenters; (2) that he or she has obtained judgments totaling a minimum threshold dollar amount (e.g., $300,000) in the area of law corresponding to one or more of the identified LawCenters; (3) that he or she (or all of the law firm's attorneys) is a member of the relevant state bar in good standing; and/or (4) that any biographical information and professional experience provided by the attorney for the ActiveLaw web site 202 is accurate and up-to-date. The representation is included in the data comprising the attorney profile record.

As with the ID and password data, CaseSmart extracts the profile data received at the web server and stores the profile data in a profile record for the particular attorney in the attorney profile database 112 connected to the web site 202. The attorney profile database 112 may be a relational database, an object-oriented database, a flat-file database, any combination of the above, or other data storage structures. Each attorney's profile record may be stored in one or more tables, objects or files. Database management applications such as creating and administering a database and database tables, and administering the creating, updating and deleting of records are common and supported by existing database applications such as, for example, Microsoft Access, Oracle, Sybase and FoxBase. Those and other database applications provide extensive database management application design tools, simplifying the design of database management applications, and those of ordinary skill understand well how to use the design tools to construct and operate such database management applications. Thus, the present invention is not limited by a particular database management application.

At a block 314 of FIG. 3, in an optional step, the attorney defines a layout to customize the appearance of his/her individual attorney information page created automatically by CaseSmart. Selecting a layout includes a series of steps. First, the attorney may select a web page design template from a list of design templates, such as by selecting one from a pull down list box of design template names. Next, the attorney may add graphic elements to the selected design template by clicking option buttons next to labels representing each graphic element desired. The attorney may then define the size and location of text or graphics, such as, for each item, selecting from automatically displayed options of small (8 points for text, 1″×1″for graphic), medium (12 points for text, 2″×2″ for graphic) or large (20 points for text, 3″×3″ for graphic) and/or selecting from LEFT, CENTER or RIGHT justification options. The attorney may, by clicking an option button labeled PHOTOGRAPH, indicate that he or she would like to supply a photograph for the individual attorney information page. In an adjoining field, the attorney then enters a filename corresponding to an image file located on storage accessible to the attorney's computer. In the same manner, the attorney may identify a video or audio file to be accessible from the attorney information page. Also, the attorney may enter the URL (Uniform Resource Locator) identifying the attorney's own web site (if he or she has one) to create a hyperlink from the attorney's information page in the ActiveLaw™ web site, to the attorney's own private web page. When some or all of these options are submitted, CaseSmart will generate an attorney information page using the supplied data. The attorney may preview the page, and revise its appearance until satisfied. It will be appreciated by those of ordinary skill in the art that other options or organization of options may be used to effect selection and layout of the attorney information page.

Optionally, the CaseSmart environment works with manually submitted information. For example, an attorney may fill in and sign paper forms to provide information, such as billing information, ID and password, agreement to adhere to specific standards, attorney profile information, selected layout for attorney information page, and the URL address of the attorney's web site. In one embodiment, the forms may be downloaded from an ActiveLaw™ web site, for example in a PDF format. The attorney may e-mail, fax or mail these forms to an administrator at an ActiveLaw™ web site 202, or may even telephone the information to the administrator. The administrator will then enter the attorney's information directly to populate new profile records.

At a next block 316, the web site provider verifies the created attorney profile record. In one embodiment, thorough verification of the attorney's background is performed including: verifying attorney membership and standing in the relevant state bar organization, verifying attorney data at a national lawyer locator service such as Martindale-Hubble; contacting the attorney's office or the affiliated law firm as indicated in the attorney profile record; sending a email message to the email address indicated in the attorney profile record. It will be appreciated by those of ordinary skill in the art that professionals, by their very nature, belong to professional associations and are licensed typically under one or more state licensing authorities. These and other sources of verification may be checked, and the present invention is not limited by any particular form of verification. It will further be appreciated that, in some embodiments, only some sources of verification information are reviewed, and, in other embodiments, no verification is performed. As discussed above, in one embodiment, the attorney provides as part of the attorney profile data a representation that the attorney meets certain standards. An ActiveLaw web site 202 operator may not verify any part of the attorney's representation, and may provide a disclaimer, viewable along with the profile data, that ActiveLaw cannot and does not guarantee the attorney representation.

Once any verification is performed, attorney profile records are activated so that they may be searched by prospective clients and so that they may contribute to the display of attorney information pages. The activation may be implemented as a boolean field labeled VERIFIED in the attorney profile record. If the VERIFIED field is false, the record is excluded from searching and no attorney information page will be generated. The verification process advantageously screens out unlicensed, unethical or unqualified attorneys.

At a further block 318 an attorney information page is automatically created based on the attorney profile record and the defined layout. The attorney information page is a web page or part of a web page that displays at least a part of the attorney profile record. Those ordinarily skilled in the art will appreciate that a web page may be created using HTML and HTML-editing software such as Microsoft FrontPage and WebEditPro. All or part of a web page may also be generated dynamically. In one embodiment, a web page template is created using tags associated with queries to the attorney profile database, the query-associated tags are populated with attorney profile data at page-request time, causing the latest attorney profile data to be displayed on the web page at run-time. Some approaches of dynamically generating web pages are described in U.S. Pat. No. 5,761,673, 5,894,554 and 5,983,227. The present invention is not limited by any technique for dynamic generation of web pages.

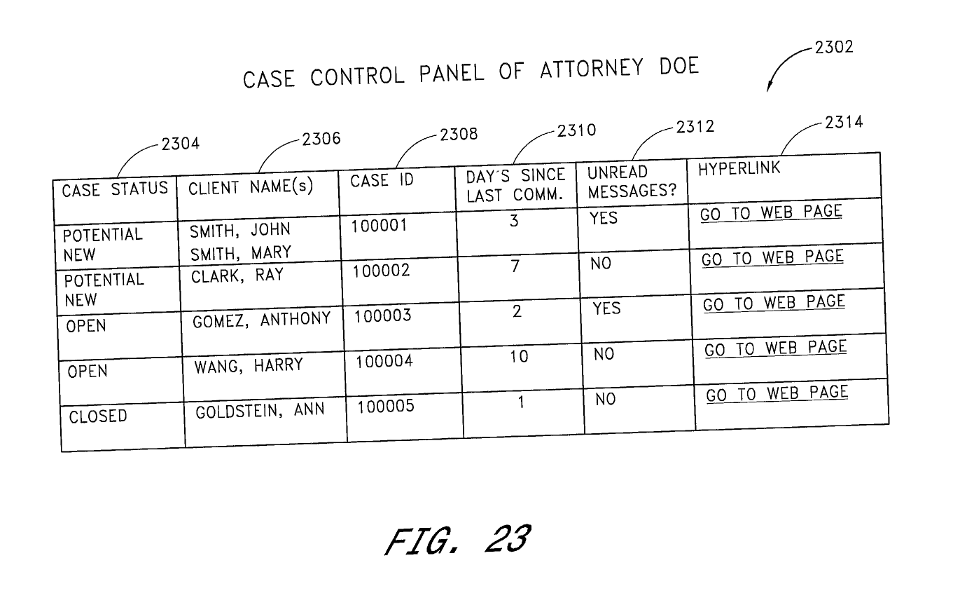

Referring now to another block 304 of FIG. 3, if the attorney is already a member then the attorney logs on to the ActiveLaw™ web site 202 using his or her attorney ID and password. At a block 320, the attorney receives a web page which includes a case control panel. Advantageously, CaseSmart generates the case control panel web page dynamically, extracting data from databases, including the case database 114. The case control panel displays information representing the attorney's open, closed and potential new cases in the CaseSmart environment. An example of a case control panel is illustrated in FIG. 23. The case control panel is the primary portal used day-in and day-out by the attorney in managing cases within the CaseSmart environment.

The case control panel also permits the attorney to update or change attorney profile information. Thus, at another block 322 of FIG. 3, if the attorney desires to update his or her attorney profile record, the attorney selects a CHANGE PROFILE hyperlink, and, at a block 324, edits fields of an update web page comprising existing profile data. When the edits are completed, CaseSmart isolates the changed data and updates corresponding fields of the attorney profile records in the attorney profile database.

The attorney may also modify the layout of the attorney information page by selecting a CHANGE INFORMATION PAGE hyperlink. Thus, at a block 326, the attorney is presented with the layout options for the attorney information page and selects any different options the attorney desires. CaseSmart receives and stores these options, in one embodiment, in an attorney information page database wherein each record includes the attorney ID and a value representing each page layout option selected and the location of each photograph or media clip identified. Thus, at a block 328, the attorney information page layout is changed based on the updated attorney profile information and the changed layout. That block 328 proceeds to an end state block 330.

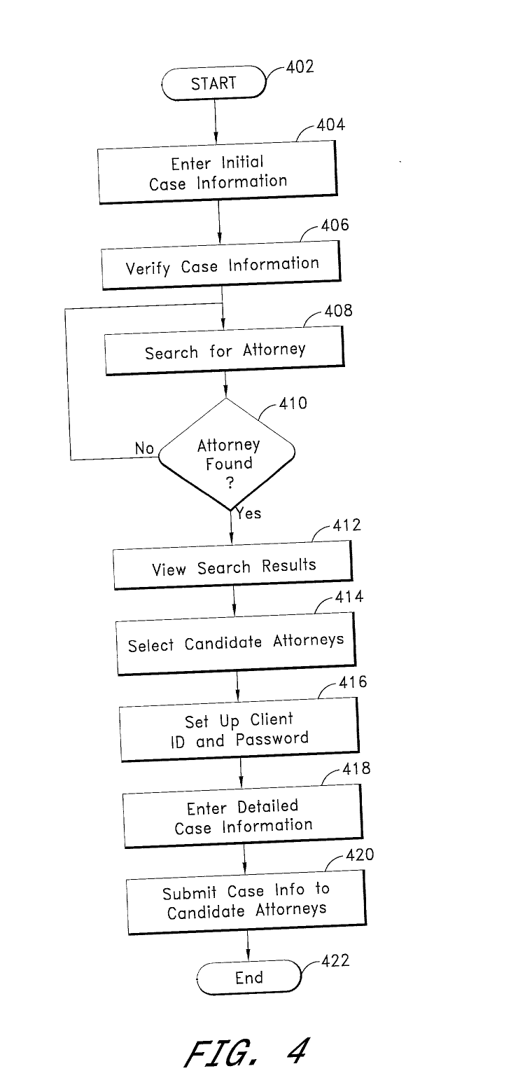

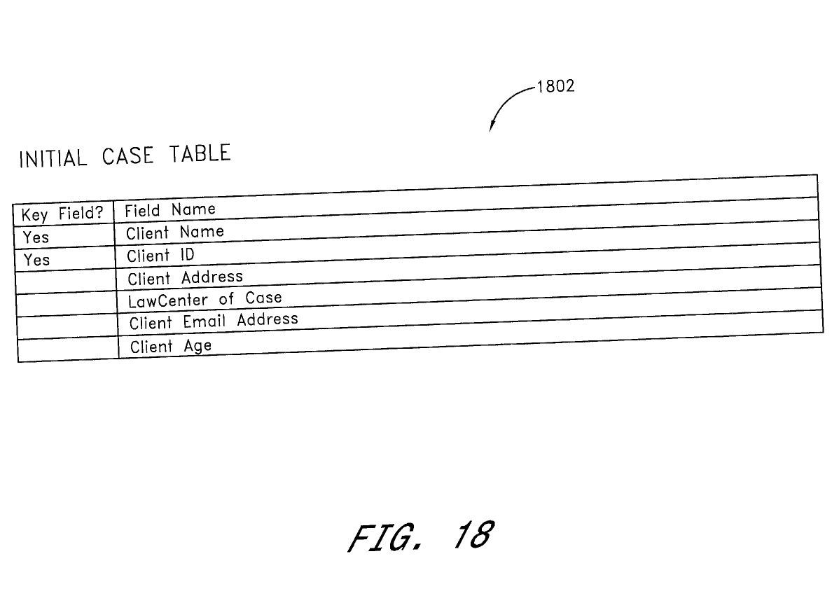

FIG. 4 is a flowchart illustrating one embodiment of the process of a client searching and selecting attorneys. A start state at a block 402 proceeds to a block 404 wherein the client enters initial case information. Initial case information may include client's name, address, area of law involved, and zip code. A client's initial case information is stored as an initial case record in the case database 114. The initial case information may include additional information, such as the client's e-mail address and age. The organization of an initial case record in accordance with one embodiment of the present invention is illustrated in FIG. 18.

At a block 406 of FIG. 4, the web site provider verifies the initial case information submitted by the client. In one embodiment, the web site provider verifies the client by sending an email to the client including a unique code and requesting that the client return that code to the web site provider. The client may be verified by other methods such as verifying the phone number identified by the client. In another embodiment, the web site provider verifies the initial case information and/or the detailed case information after the client has viewed search results at a block 412 or before submitting the case information to an attorney at a block 418.

At a next block 408, the client enters one or more search conditions to search for an attorney whose skill and experience are appropriate to represent the client in a particular legal matter. Search conditions may include the state where the attorney is licensed, the location of the attorney office, the language skill of the attorney or the office staff, the practice sub-area of the attorney, client-entered keywords, and so forth. The web site search engine searches the activated attorney profiles in the attorney profile database 112 for attorneys whose profiles at least partially match the user-entered search conditions. A CaseSmart search engine uses the search conditions to search the attorney profiles.

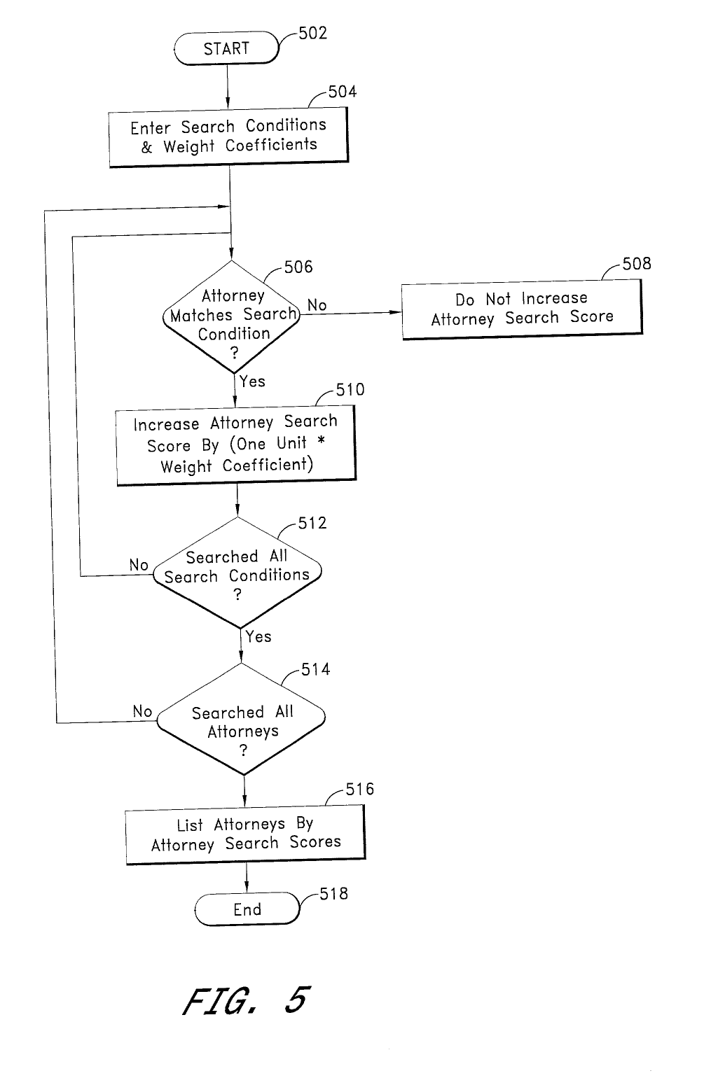

In one embodiment, a client assigns different weights to each search condition to reflect the importance attached to a match in the respective search condition. In another embodiment, the CaseSmart search engine automatically assigns a weight coefficient to each search condition based on each search condition's order of appearance identified by the client. In yet another embodiment, the search engine assigns equal weight to all search conditions. FIG. 5, discussed in detail below, illustrates one embodiment of a weighted search process.

At another block 410 of FIG. 4, a determination is made as to whether at least one attorney is found, e.g., one attorney profile record includes data at least partially matching search criteria. If no attorney is found, then the client, again at the block 408, modifies the search conditions for another search. If, however, at least one attorney is found, then at a block 412, information representing the found attorney(s) is organized and formatted within a dynamic web page and is presented to the client. In one embodiment, the attorney information is displayed according to closeness of the match detected by the search engine. Preferably, only a predetermined maximum number of attorneys (for example, no more than five) are displayed to the client. In another embodiment, no less than a predetermined minimum number of attorneys are displayed. The client may click a hyperlink associated with a displayed attorney to view the corresponding attorney information page. In one embodiment, the client may conduct a narrower second search to identify a subset of attorneys found by the first search, who more closely match the client's needs.

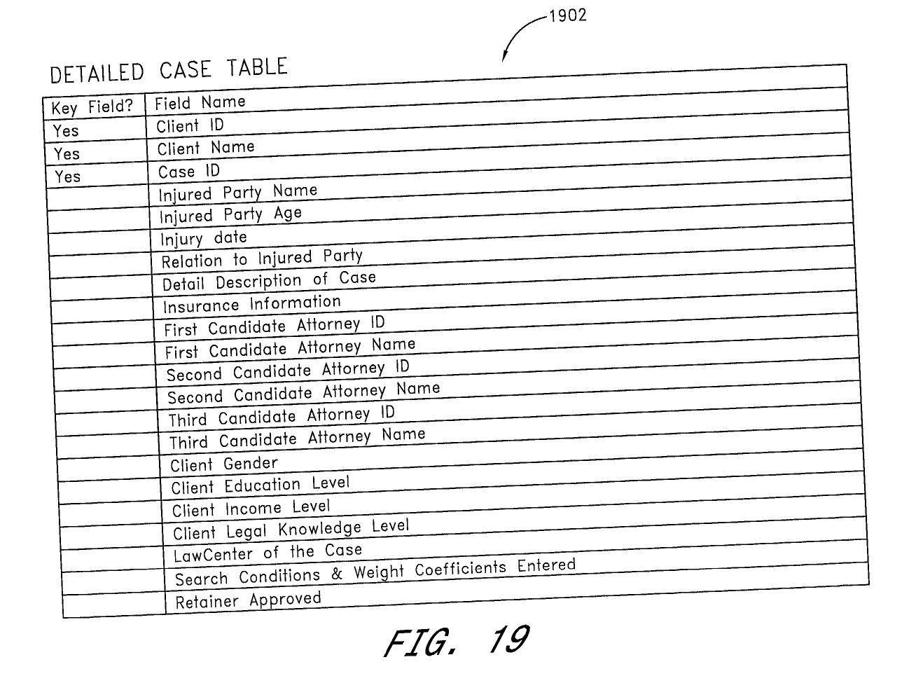

At a block 414, the client selects one or more candidate attorneys from the found attorneys to which the client will submit his or her case for the attorney to review. At a block 416, the client is prompted to set up a client ID and a password. At a block 418, the client is prompted to enter detailed case information that describes the case he or she would like the selected attorneys to consider. CaseSmart creates a detailed case record in the case database 114, automatically generates a unique case ID number, and stores the unique case ID number in the case ID field of the new detailed case record. The fields of the new detailed case record correspond to the fields of the detailed case table, and example of which is shown in FIG. 19. CaseSmart also stores the client ID and the client name in respective client ID and client name fields. In addition, CaseSmart stores the attorney ID and attorney name information for each candidate attorney in respective candidate attorney ID and candidate attorney name fields.

In one embodiment, the client is prompted to complete an on-line detailed case submission form based on the characteristics of the case and the client. CaseSmart uses the detailed case information provided by the client to further populate the new detailed case record in the case database 114. Thus, CaseSmart prompts the client for information such as name of injured party, age of injured party, injury date, client's relationship to injured party, and insurance information. CaseSmart also stores an initial value of TRUE in a retainer approved field, which may be modified later in circumstances warranting further inquiry into whether a client should execute a retainer.

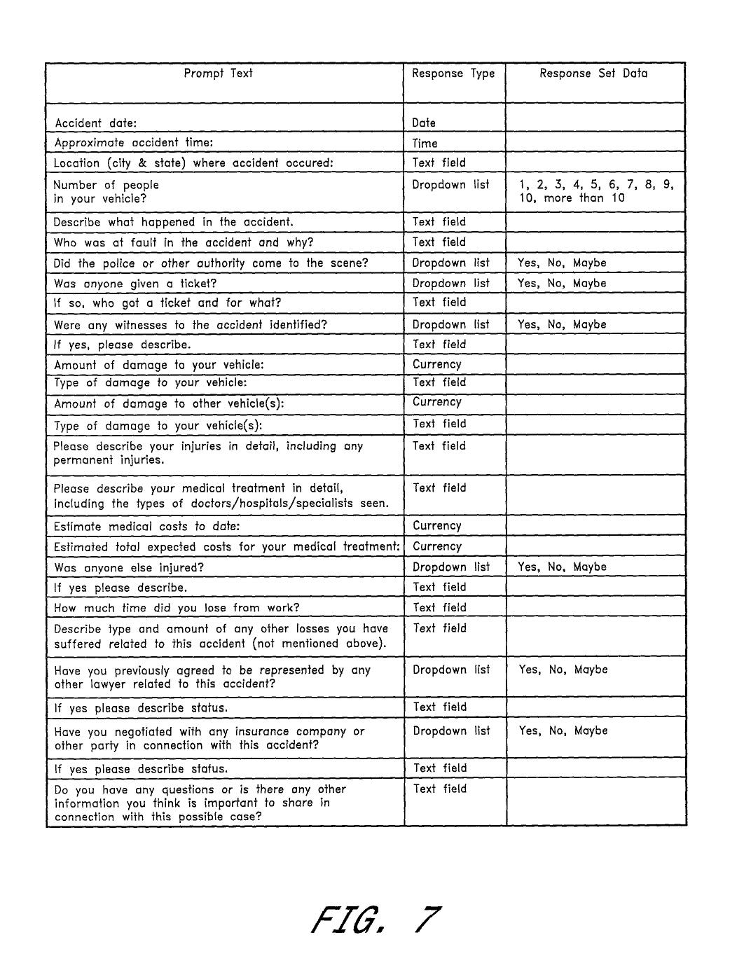

The CaseSmart environment advantageously provides numerous detailed case submission forms, and CaseSmart presents the client with a particular detailed case submission form designed to obtain information relevant to the client's particular type of case. An example of a detailed case submission form is illustrated in FIG. 7, in the context of an automobile accident case. In one embodiment, the client is shown a warning message that he/she must enter the detailed case information truthfully and in good faith to retain an attorney. Such message advantageously discourages frivolous use of an ActiveLaw™ web site, including pranks. The information from the detailed case submission form, in one embodiment, is stored in a detailed description of the case field of the detailed case record.

At a next block 420, CaseSmart submits the client's initial case information and detailed case information to the candidate attorneys selected by the client. In one embodiment, the case information is sent to a pre-retainer case page. The candidate attorneys are each sent an email inviting them to visit the pre-retainer case page, with the email preferably including a hyperlink to the pre-retainer case page.

In another embodiment, the case information is submitted by email (preferably encrypted) to the email addresses of the candidate attorneys. It will be appreciated that each email address is obtained by querying the attorney profile records using the candidate attorney ID fields from the detailed case information record. The candidate attorney email addresses are returned in a resulting recordset for use in automatically generating email messages. In one embodiment, a Cold Fusion program routine directs an email service application such as Novell Internet Message System to send email messages to the candidate attorneys.

In an alternative embodiment, a phone message is automatically sent to the candidate attorneys informing each that he or she has been selected by the client as a candidate attorney. Those ordinarily skilled in the art will appreciate that existing solutions may be utilized to provide automated dialing using phone numbers stored in a database. For example, END Software Corp. of Shawnee, Kansas provides computer telephony solutions such as automated dialing. In another embodiment, an administrator may contact each candidate attorney and inform each of the client's prospective selection. Block 420 proceeds to an end state block 422.

FIG. 5 is a flowchart illustrating one embodiment of a weighted search process for searching multiple search conditions. A start state of block 502 proceeds to a block 504, where the client is prompted to enter multiple search conditions. In one embodiment, the client is prompt to select from a drop-down list of search conditions such as language skill of the attorney, location of the attorney office, state where the attorney is licensed, practice sub-areas of the attorney, and so forth. The client is also prompted to identify a weight coefficient for each entered search condition to indicate the importance of the respective search condition. In one embodiment, the client assigns a numeric value or a percentage value to each search condition as a weight coefficient. In another embodiment, the client selects a value from a range of values such as “high importance”, “medium importance” and “low importance” to attach to each search condition, with each of such values having a predefined numeric value as a weight coefficient. In yet another embodiment, the client arranges the order of the entered search conditions, with a weight coefficient assigned to each search condition depending on its arranged order.

At a block 506, the CaseSmart search engine compares an attorney profile record with a search condition. If an attorney profile record matches and/or at least partially matches a search condition, then, at a block 510, the attorney's search score is increased by one unit number multiplied by the respective weight coefficient. Otherwise the search score is unchanged at a block 508. At another block 512, the search engine determines if all search conditions have been compared with the attorney profile record. If not, the search engine returns to block 506 to compare another search condition with the attorney profile record. After all search conditions have been compared with the attorney profile record, at a block 514 the search engine determines if all attorney profile records have been searched. If not, the search engine returns to block 506 to compare search conditions with another attorney profile record. Otherwise the search engine proceeds to block 516 and lists matched attorneys in the order of search scores.

In one embodiment, the five attorneys with the highest search scores are displayed to the client as search results. In another embodiment, if two attorneys have the same search score, the attorney who uses a preferred version of the case communication module 118 (such as, for example, a version of the case communication module 118 having one or more additional features such as, for example, an auto-paging feature that dials or otherwise activates an attorney's pager when a client has posted a message or other communication for the attorney) is ranked higher, because such preferred version of the case communication module 118 provides more functions and promotes better service to the client. Block 516 proceeds to an end state block 518.

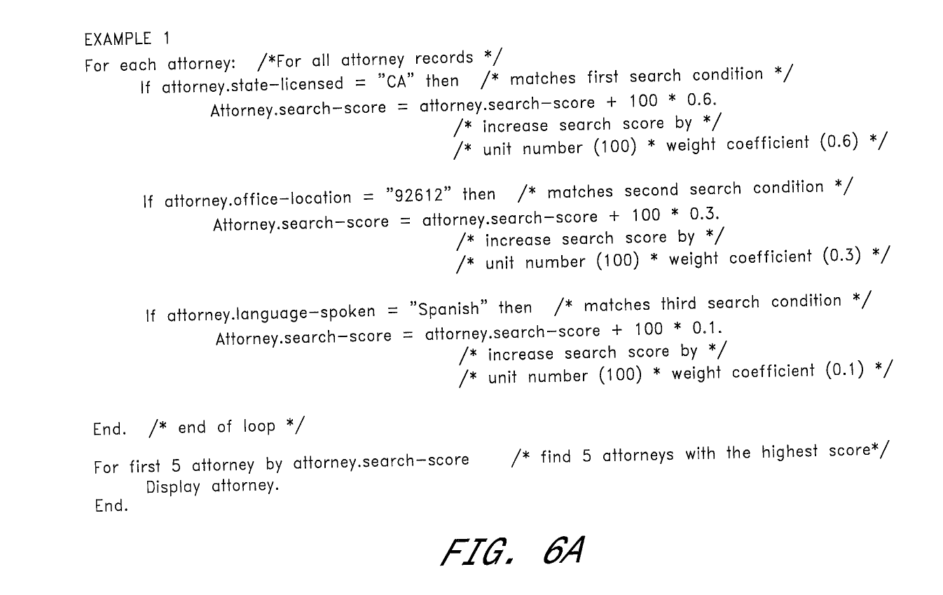

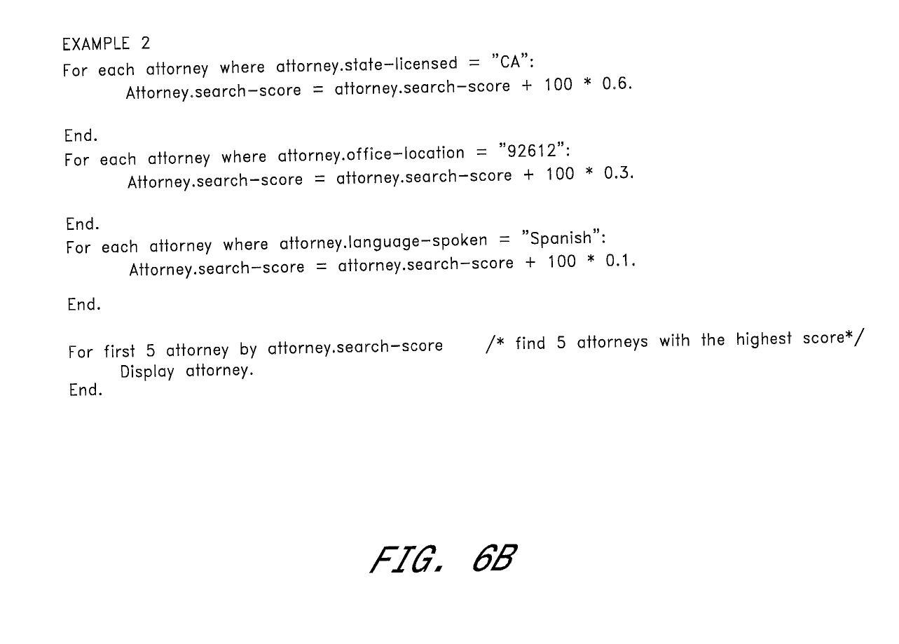

In another embodiment, the search engine searches all attorney profile records for records that match and/or at least partially match one client-entered search condition. A search score (one unit number multiplied by the weight coefficient) is stored for each matched attorney. In one embodiment, the search condition corresponds to an indexed field of the attorney profile record, so that an indexed (and faster) search is performed. The search engine then searches all attorney profile records for records that match and/or at least partially match another client-entered search condition. A search score is stored or increased for each matched and/or partially matched attorney. After all search conditions have been searched, the matched and/or partially matched attorneys are listed by the order of their search score totals. Other embodiments of searching for multiple matches among attorney profile records may also be implemented. FIGS. 6A and 6B illustrate examples of pseudo-code supporting a weighted search process. In a further embodiment, the client may enter multiple keywords each with a respective weight coefficient as search conditions.

One embodiment of the search process allows for partial matches. For example, a search condition of “attorney office zip code=92660” may be considered a partial match with an attorney profile record of a zip code “92612”, with the first three digits of the zip codes being identical. The search score is then increased, e.g., by one unit number multiplied by the weight coefficient multiplied by partial match value, with the partial match value being a decimal number between 0 and 1.

In another embodiment, the search process locates attorneys available to practice in the zip code provided by the client and/or attorneys in nearby zip codes. More specifically, the search process will return up to five attorneys whose profile data match the zip code entered by the client. If fewer than five attorneys are located whose profile data match that zip code, then the search process locates attorneys in nearby zip codes. The nearby zip codes are searched in a nearest first order, until a total of five attorneys are located. However, the search process will not return information about attorneys located more than a predetermined maximum distance (e.g., 40 miles) from the zip code provided by the client. In performing such search, the search engine searches zip code field entries in each member attorney's profile data records. The search engine also accesses a nearby-zip code table to identify a set of zip codes nearest to the zip code entered by the client. Thus, for each possible zip code, the nearby-zip code table provides a list of zip codes in a nearest first order, the list including only zip codes including areas within the predetermined maximum distance from the zip code entered by the client. Each zip code in the identified list of nearby zip codes is used to search through the zip code field entries in each member attorney's profile data records, until five attorneys have been identified. In one embodiment, the search engine is implemented using a CF₁₃ ZipRad routine—supplied by DBActive—designed to operate with Cold Fusion Server. Those of ordinary skill in the art will appreciate that CF_ZipRad returns a list or result set of all zip codes within a given radius of a supplied zip code. CF_ZipRad accesses an available zip code database to supply results.

The search process may also allow for keyword searches. In one embodiment, the search engine searches a law practice description field of attorney profile records to look for at least partial matches with the client-entered keywords. It will be appreciated by those of ordinary skill that the present invention may accept additional search criteria from clients and may search any of the attorney profile data for full or partial matches.

FIG. 7 is an example of a detailed case submission form. The form illustrated in FIG. 7 relates to automobile accident cases. The present invention is not limited by any particular context or case type for a detailed case submission form. In the form of FIG. 7, each row represents an entry for the client to complete. The “Prompt Text” column contains the text with which to prompt the client to complete the entry. The “Response Type” column is an internal field indicating the type of data for the entry. The “Response Set Data” column contains the possible choices for drop-down list entries. Advantageously, CaseSmart includes many predetermined detailed case submission forms for a variety of legal matters, thus expediting the isolation of important information, the nature of which changes from legal matter to legal matter. The submission forms may be delivered, completed and returned through web page-based or email-based transactions, or may be delivered, completed and returned manually, through fax or mail transactions.

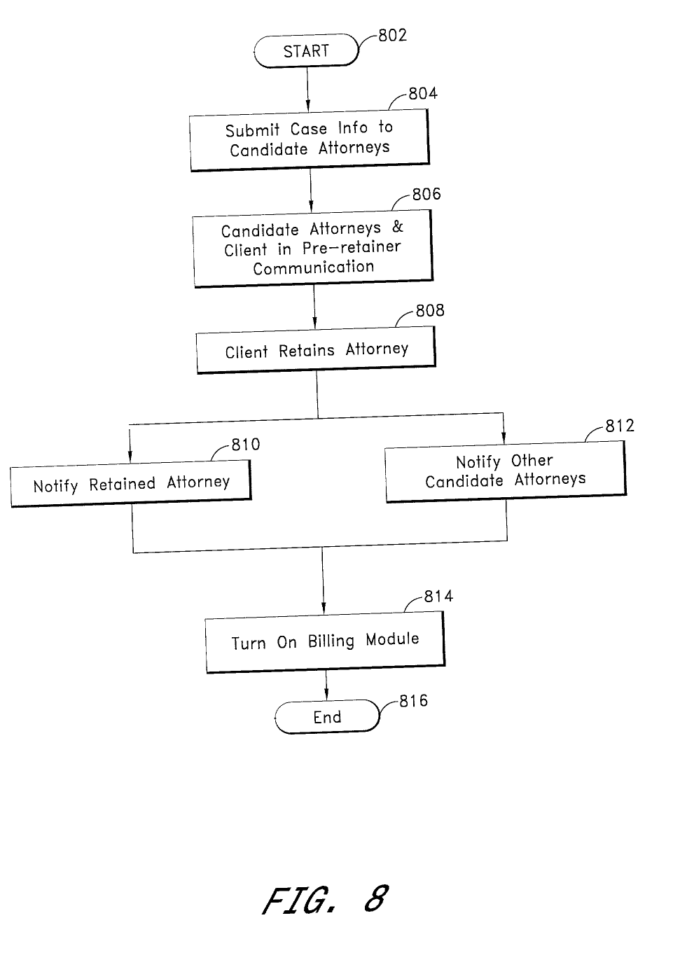

FIG. 8 is a flowchart illustrating one embodiment of a general process for pre-retainer communication between the client and the candidate attorneys and for retaining and billing an attorney. A start state at a block 802 proceeds to a block 804, wherein the client's initial and detailed case information is submitted to the candidate attorneys. At a block 806, a candidate attorney engages in pre-retainer communication with the client. Preferably, the candidate attorneys and the client use CaseSmart's pre-retainer communication module 116 and exchange web page-based communications. The preretainer communication module 116 is integrated with the attorney profile database 112 and the case database 114 to provide the client and the candidate attorneys with easy access to and management of information. The pre-retainer communication module 116 also provides security measures such as encryption and password protection to ensure the communications remain confidential. One embodiment of the pre-retainer communication module 116 uses VeriSign Server ID and Secure Sockets Technology to provide that security. While client and candidate attorney communication is preferably web page-based, in another embodiment, client and candidate attorneys communicate through secure email messages and/or chat features provided by the pre-retainer communication module 116. Client and candidate attorneys may also communicate via conventional email, telephone or person-to-person meetings. Advantageously, the preretainer communication module 116 facilitates secure discussions wherein the client decides which attorney to retain, and each candidate attorney determines whether he or she would be interested in representing the client.

At a block 808, the client decides to retain one attorney from the candidate attorneys. The attorney presents to the client and the client signs a retainer agreement with that attorney (the retained attorney). In one embodiment, the presentation and signature of the retainer agreement are completed electronically using the pre-retainer communication module 116. For example, after being presented with an electronic copy of the attorney's retainer agreement, which CaseSmart may forward automatically, the client provides verification information such as social security number and mother's maiden name, and clicks an “I Accept” button as a signature. The information entered by the client and the retainer agreement are stored together by CaseSmart as a digitally signed document. The digitally signed document's privilege setting is preferably set to “cannot-modify” and “cannot-delete” to prevent alternation or deletion. In another embodiment, the client signs the retainer agreement offline, the retained attorney then notifies the web site provider that the retainer has been signed, which, in turn, starts the billing process.

At a block 810, the pre-retainer communication module 116 notifies the retained attorney that the client has signed the retainer agreement. At a next block 812, the preretainer communication module 116 notifies the unretained candidate attorneys that the client has retained another attorney, and that the other candidate attorneys will no longer be able to communicate with the client about the case using the pre-retainer communication module 116. In one embodiment, the notifications are made in the form of automatically generated email messages and/or phone messages.

At a further block 814, the billing module is turned on for the retained attorney. In one embodiment, the billing module charges an amount to the attorney's credit card account every month for using the CaseSmart environment to manage the case. In another embodiment, the billing module sends an invoice, e.g., monthly, to the attorney for use of CaseSmart. Block 814 proceeds to an end state block 816.

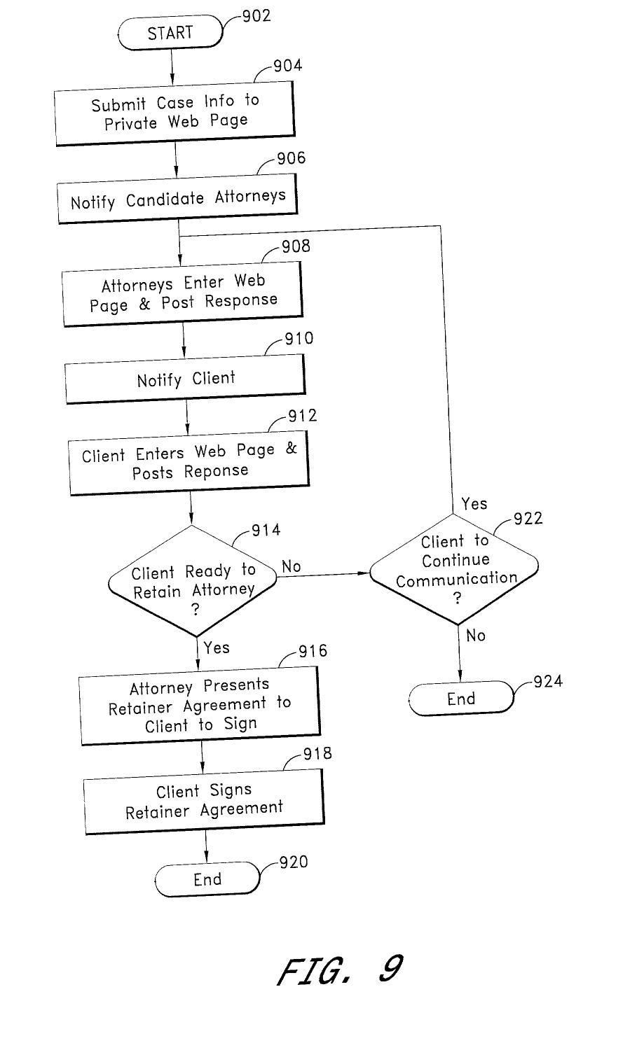

FIG. 9 is a flowchart illustrating one embodiment of a process of pre-retainer communication between the client and the candidate attorneys and of retaining an attorney. A start state at a block 902 proceeds to a block 904 wherein the initial case information and detailed case information submitted by the client are stored in a preretainer case page for that particular case. At a block 906, CaseSmart notifies the candidate attorneys that they have been selected as candidates for a potential new case, and invites the candidate attorneys to visit the pre-retainer case page to review the case information and respond to the client. In one embodiment, the notification is in the form of automatically generated email messages with hyperlinks to the pre-retainer case page. The pre-retainer case page is generated by a sub-module of CaseSmart's preretainer communication module 116. At a block 908, the candidate attorneys review case information in the pre-retainer case page and post responses to the client on the pre-retainer case page.

At a block 910, the pre-retainer communication module 116 notifies the client that a response has been posted by a candidate attorney and invites the client to visit the pre-retainer case page to view the response. At a next block 912, the client reviews the attorney responses on the pre-retainer case page and posts any responses to attorneys. At a block 914, if the client is not yet ready to retain the attorney, then at a block 922 it is determined whether the client wishes to continue communicating with the candidate attorneys. If so, then the client and the candidate attorneys repeat communication at the block 908 or the block 912. If the client wishes to terminate communication, then block 922 proceeds to an end state at a block 924. If the client is ready to retain an attorney, then block 914 proceeds to a block 916.

At the block 916 of FIG. 9, the attorney presents a retainer agreement to the client. In one embodiment, the attorney presents an electronic copy of the retainer agreement to the client for the client to sign. At another block 918, the client signs the retainer agreement, preferably using a digital signature. In one embodiment, the client is shown a warning screen informing the client that he/she is signing a contract before being allowed to sign. In one embodiment, prior to permitting the digital signature, the pre-retainer communication module 116 checks the prior dates on which the client has signed other retainer agreements, and if the client is attempting to sign more than one retainer agreement per time period (such as, for example, per year), the pre-retainer communication module stores a FALSE value in a retainer approved field of the detailed case record for the present case. When the retainer approved field is set to FALSE, CaseSmart does not permit the client to complete the retainer agreement.

Restricting a client to a single retainer agreement in any one time period advantageously helps ensure that the client takes the retaining process seriously and helps prevent situations where the client may be attempting to retain a second attorney for a legal matter in which the client is already represented. Thus, when a client attempts to complete a second retainer in a single time period, the pre-retainer communication module 116 displays a message indicating that the client may not complete the retainer agreement. The message also indicates that the client should contact an administrator of the ActiveLaw web site 202 to inquire about completing the retainer. It will be appreciated that a client may legitimately have multiple legal matters arising within a particular time period, each matter requiring attorney representation. Thus, even though the client in such cases will not immediately be permitted to retain a second attorney using the normal provisions of CaseSmart, the client may contact the ActiveLaw web site 202 administrator and, in appropriate circumstances, the administrator will waive the prohibition by resetting the retainer approved field to TRUE. When the retainer approved field has been set to TRUE, CaseSmart permits the client to complete the retainer agreement as normally permitted at the block 918. Block 918 proceeds to an end state at a block 920.

In another embodiment, the pre-retainer communication module 116 does not use a pre-retainer case page, but submits case information to candidate attorneys in the form of email messages. The candidate attorneys and the client communicate via email messages. It will be appreciated by those of ordinary skill in the art that the present invention is not limited by particular techniques for exchanging communications.

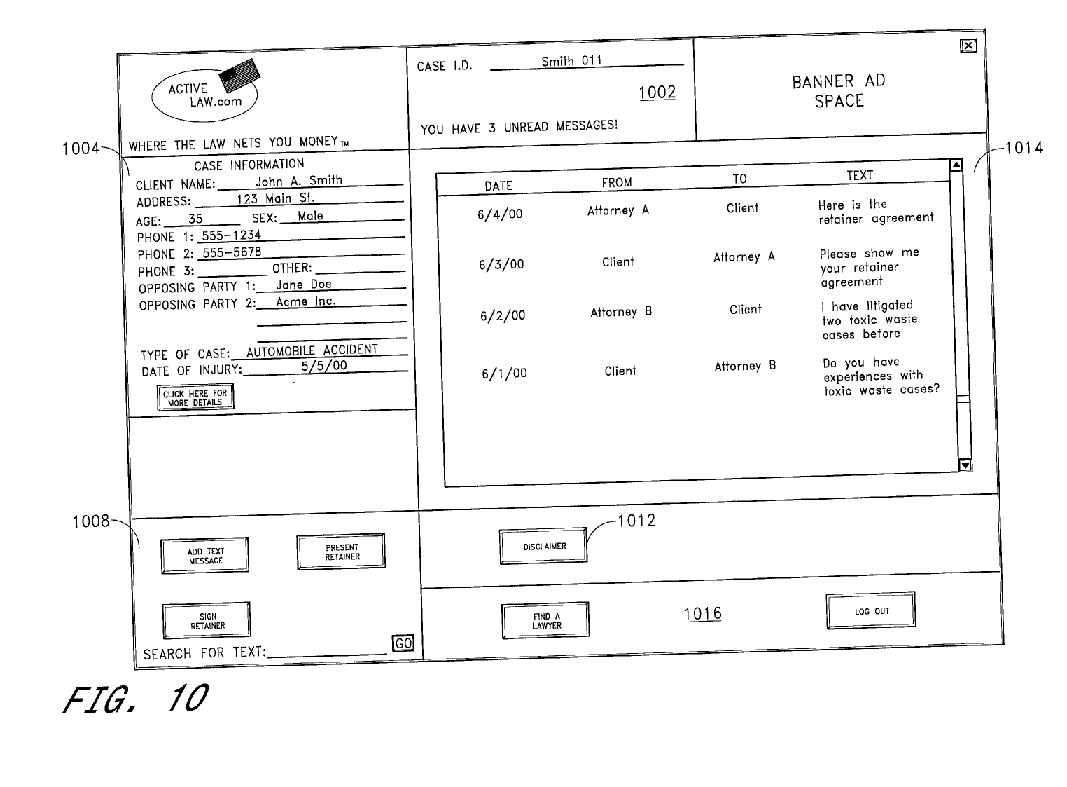

FIG. 10 illustrates one example of a pre-retainer case page. In one embodiment, the client and attorney access the pre-retainer case page, with the attorney accessing that page by simply clicking on the corresponding client name (see FIG. 23 item 2306) on the case control panel, which name labels a hyperlink associated with the screen area displaying the client name, the hyperlink referencing a URL or other designator of the pre-retainer case page. Similarly, when a client enters a password, CaseSmart presents a selectable option to view a pre-retainer (or post-retainer) page for each case of the client.

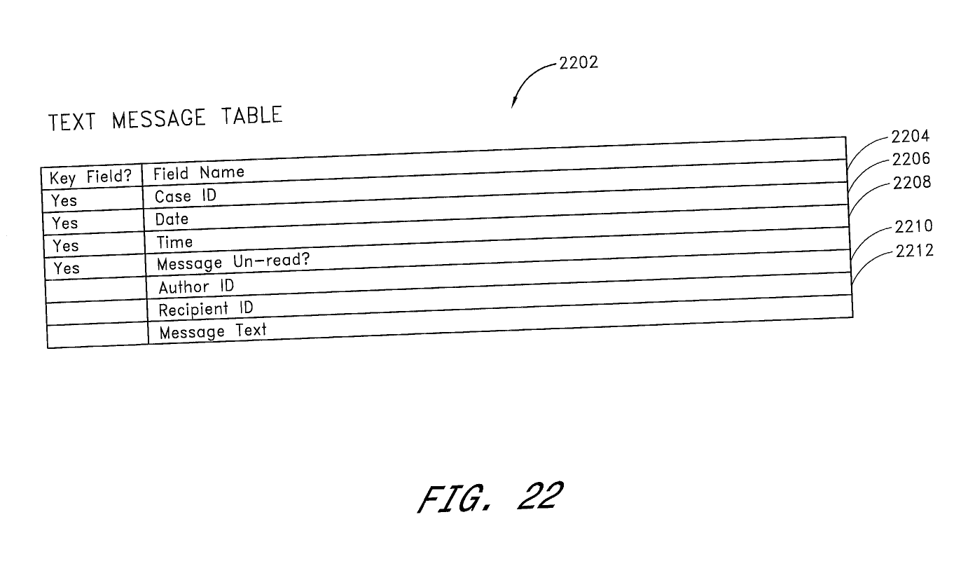

Section 1002 of the pre-retainer case page displays case ID, and the number of any unread text messages. In one embodiment, CaseSmart determines the identity of the viewing person by the client ID or the attorney ID entered. CaseSmart then searches the text message table illustrated in FIG. 22 for unread text messages having a matching case ID and recipient ID.

Section 1004 of the pre-retainer case page displays selected case information stored in the initial case table and the detailed case table. Those of ordinary skill will appreciate that the case ID may be used to query the case database records to obtain the initial case data and the detailed case data related to any particular case. CaseSmart is advantageously configurable to select fields from the initial and detailed case data for display on the pre-retainer case page. The client or the attorney may click on a hyperlink to request and receive more details of case information on another page.

Section 1008 allows the attorney or the client to enter text and search for text messages that contain certain text. Section 1008 also displays action buttons that allow the attorney or the client to add a text message (i.e., post a message). If the viewing person is a client, then selecting the add text message button causes a list of candidate attorneys to appear, and the client may select one or more as the recipient of the text message. Section 1008 also displays action buttons that allow the attorney to present a retainer agreement to the client and to allow the client to digitally sign the retainer agreement. Section 1012 of FIG. 10 displays disclaimer messages.

Section 1014 of FIG. 10 displays text messages in chronological order. The section 1014 is pre-scrolled to display current messages, but includes a scroll bar to access earlier messages. In one embodiment, when the viewing party is the client, CaseSmart separates text message display area of section 1014 into multiple sections or multiple screens, each displaying text messages from one candidate attorney. Section 1014 displays links to other parts of the ActiveLaw™ web site, the link to log out, and any miscellaneous messages.

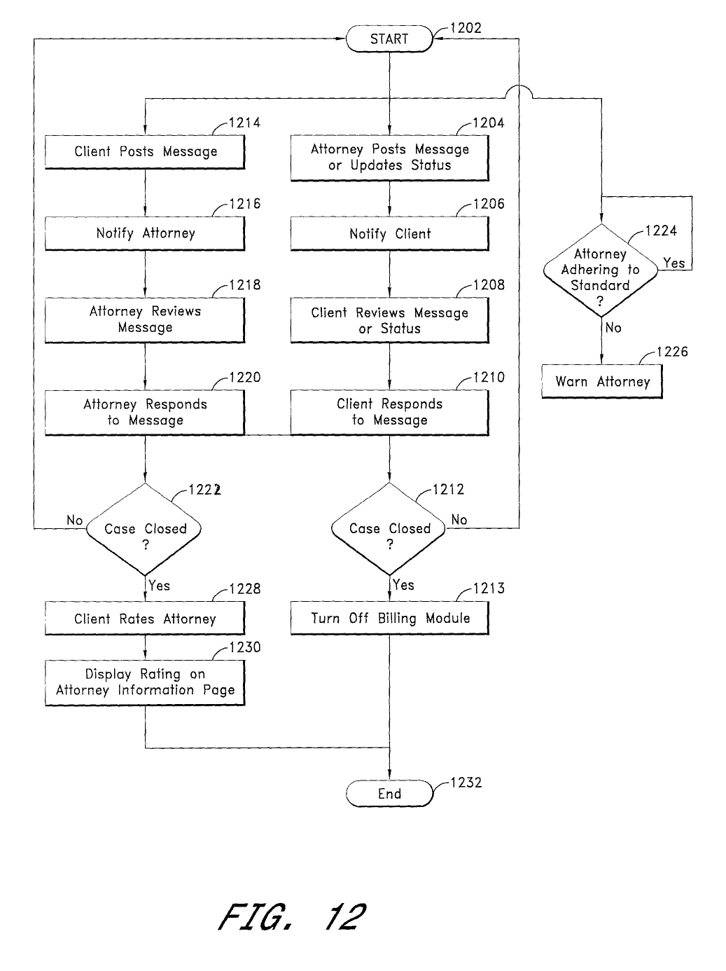

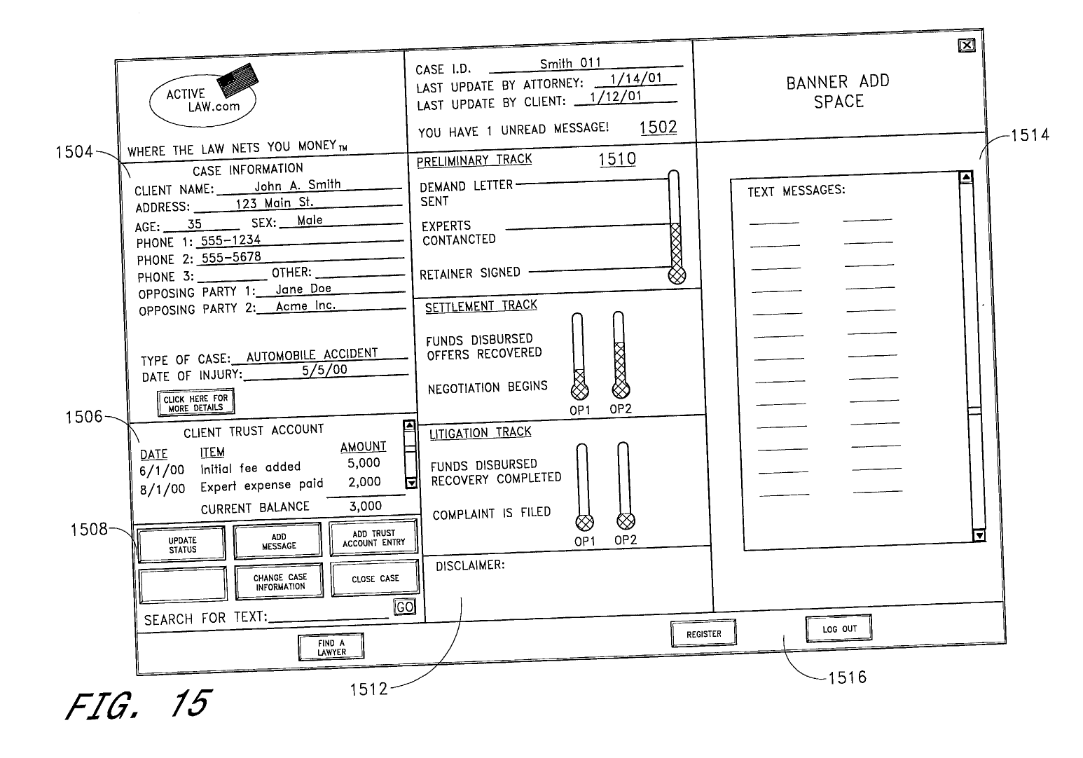

FIG. 12 is a flowchart illustrating one embodiment of a case communication process between the client and the retained attorney and of a process of closing a case and rating an attorney. As a case progresses, the retained attorney and the client communicate about the case using CaseSmart's case communication module 118. The case communication module 118 is integrated with the attorney profile database 112 and the case database 114 to provide the client and attorneys with easy access to information regarding the attorney, the client and the case. The case communication module 118 also provides security measures such as encryption and password protection to ensure the communications remain confidential. Client and attorney preferably communicate by accessing web page-based messages left for each other. Client and attorney may also communicate through secure email messages and chat features provided by the case communication module 118. One embodiment of the case communication module 118 uses VeriSign Server ID and Secure Sockets Technology to provide security. Client and attorney may also communicate via conventional email, telephone or person-to-person meetings. In a preferred embodiment, the attorney and the client communicate on a post-retainer case page illustrated in FIG. 15. The post-retainer case page is accessible to both client and attorney in the same manner as the pre-retainer case page.

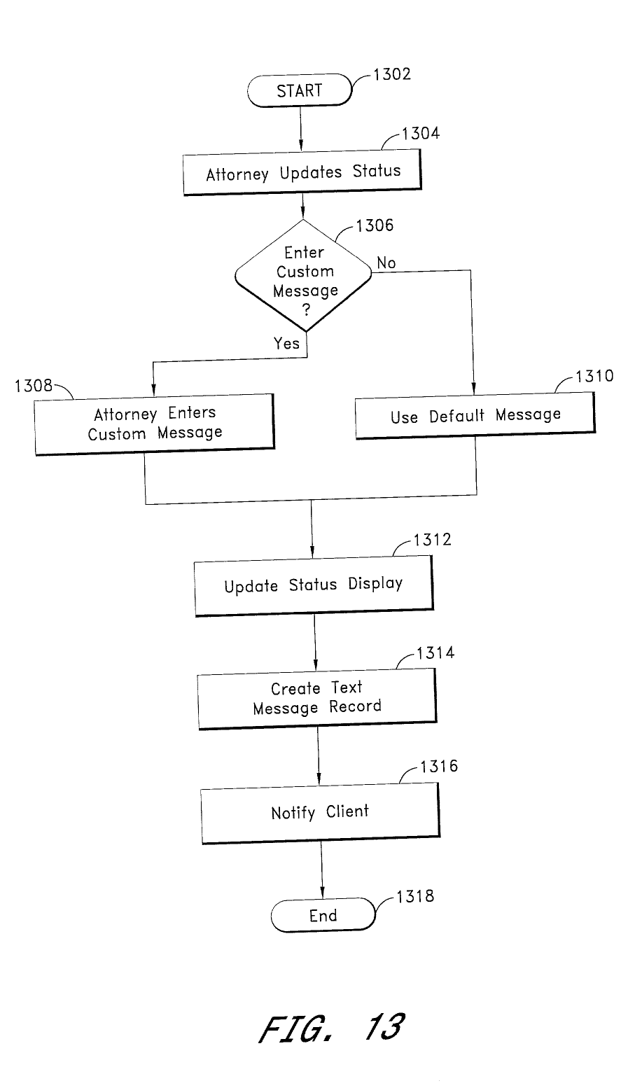

In FIG. 12, a start state block 1202 proceeds to a block 1204, a block 1214 and a block 1224. At the block 1204 of FIG. 12, the retained attorney uses the case communication module 118 to post a message to the client or to update case status information. Case status information includes the stage of the case's progress, such as ordering medical records, negotiating settlement agreement with opposing party, and so forth. Case status information may also include trust account current balance, attorney's last update date, client last review date, hours the attorney has spent on the case, and so forth. The case communication module 118 stores the date on which any update or message is posted by an attorney in a last update date field associated with the case in a case status table in the case database 114. This last update date field thus holds the last date the attorney communicated with the client about the case. At a block 1206 the case communication module 118 notifies the client that the retained attorney has posted a message for the client or updated the status of the case, advantageously in the form of automatically generated email messages and/or phone messages. A more detailed illustration of one embodiment of the notification process is shown in FIG. 13, discussed below. At a block 1208 of FIG. 12, the client uses the case communication module 118 to review the message or the status of the case. At a block 1210 of FIG. 12, if a message has been posted for the client, the client responds to the message by posting a response on the post-retainer case page. The process of a client posting a message is also illustrated at block 1214. At a block 1212, if the case is not closed, then the communication process repeats. If the case is closed then the billing module is turned off at a block 1213, so that the attorney is no longer charged for using CaseSmart on this case. Block 1213 proceeds to an end state at a block 1232.

At the block 1214, the client posts a message for the attorney using the case communication module 118. At a next block 1216, the case communication module 118 notifies the attorney that a message has been posted for him or her to review. At a block 1218, the attorney reviews the message, and responds to the message at a block 1220. At another block 1222, if the case is not closed, then the communication process repeats.

If the case is closed, then the client rates the attorney's service at a block 1228. In one embodiment, the case communication module 118 prompts the client to enter a numerical value representing the client's opinion on attorney responsiveness, attorney trustworthiness, attorney competence, overall satisfaction, and so forth. In one embodiment, the case communication module 118 sends the client's rating entries to the attorney being rated as feedback information. Attorney rating information may also include comments entered by the client about the attorney. Attorney rating information cannot be updated or created by the attorney. In one embodiment, the client is allowed to rate the attorney only after the case has closed. In another embodiment, the client may rate the retained attorney at any time.

The rating information is stored in the attorney profile database 112, particularly as part of the appropriate attorney profile records. In one embodiment, this information may be modified or edited by an ActiveLaw administrator prior to being stored in profile records. In one embodiment, attorney rating information is classified by and/or correlated to client and case characteristics such as LawCenter, client's age, gender, educational level, income level, and legal knowledge level. Such classification and correlation advantageously provide useful information to future clients or prospective clients. At a block 1230, the attorney rating information is made available for display on the attorney's attorney information page. Block 1230 proceeds to an end state at a block 1232.

The case communication module 118 continuously monitors the dates and frequency of attorney-client communication to ensure that the attorney adheres to the specific standards of service to which he or she agreed upon becoming a member of the ActiveLaw™ web site. At a block 1224, the case communication module 118 determines whether the attorney has adhered to the higher standard of service. More particularly, the case communication module 118 compares the current date to the last update date in the case database to determine the gap in time between the current date and the last communication from the attorney to the client about the case. If the gap has grown to within three days of the time period in which communication is required (e.g., two weeks), the case communication module 118 automatically generates a warning message so informing the attorney.

If the gap has grown to equal or exceed the time period in which communication is required—i.e., attorney has not adhered to the higher standard of service—the case communication module automatically sends a message so informing the attorney at block 1226. In one embodiment, the case communication module sends an automatically generated email message/phone message. In one embodiment, the message is also sent to the client and to an ActiveLaw™ administrator. The monitoring is carried out from the time the attorney is retained to the time the case is closed. As discussed above, the attorney may, in certain embodiments, agree to one or more of a variety of consequences, including those discussed above, triggered by detecting a predetermined number of instances in which the attorney's communication was not sufficiently timely. Those of ordinary skill will appreciate that such enforcement of specific standards applies to any profession, and the present invention is not limited by a particular profession.

In a preferred embodiment, CaseSmart allows the attorney and client to agree that for a determined time period, the attorney need not communicate with the client about the case. CaseSmart also permits a predetermined number of vacation time periods. Such time periods permit the attorney brief absences for emergencies or vacations. During these time periods, CaseSmart will avoid checking whether the attorney has adhered to the communication frequency guidelines otherwise enforced.

FIG. 13 is a flowchart illustrating one embodiment of the case status update and notification process. A start state at a block 1302 proceeds to a block 1304 wherein a retained attorney updates case status information. Case status information includes the stage of the case's progress, such as ordering medical records, negotiating settlement agreement with opposing party, and so forth. Case status information may also include trust account current balance, attorney's last update date, client last review date, hours the attorney has spent on the case, and so forth. In one embodiment, the attorney may modify or cancel the case status information which the attorney entered prior to a fixed period or “freeze period” such as, a period beginning, for example, 24 hours after entry of the information and enduring for a period of, for example, five years after the close of the case. During the freeze period, the attorney may not modify or cancel the case status information.

In another embodiment, the client may modify case information the client entered prior to, but not during, the freeze period. In still a further embodiment, both the client and the attorney may modify case information each respectively entered prior to, but not during, the freeze period.

CaseSmart advantageously retains the information pertaining to a case, including case description information, communications and status updates, for retrieval even after delivery of services has been completed. In one embodiment, CaseSmart retains the information for a period of five years after the delivery of services has been completed. An archive retrieval module of CaseSmart permits entry of search criteria such as, for example, professional name, client name and/or case ID values, and, when a SEARCH button is selected, the archive retrieval module automatically forms queries using those values and returns a displayable report including case description information for all cases having records that match or partially match the search criteria. It will be appreciated by those of ordinary skill that other search criteria may be used and the period of time for which case information is retained may be more or less than five years.

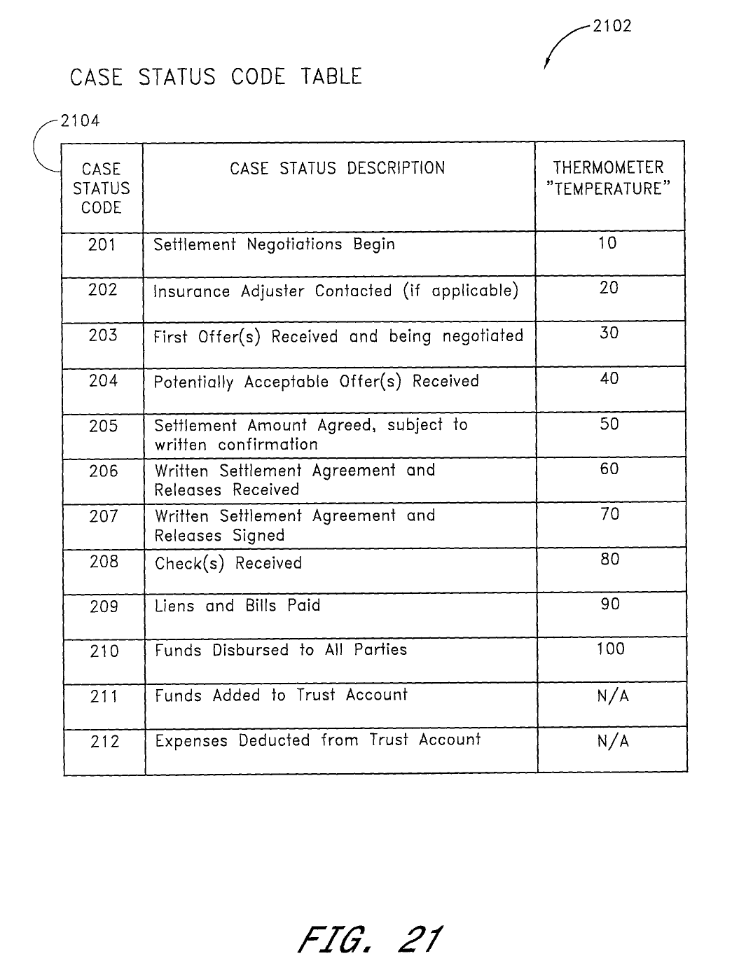

At a block 1306, the attorney determines if he or she wants to enter a custom text message to be associated with the update event. If the attorney wants to enter a custom message, then at a block 1308 the attorney enters a custom text message. Otherwise, at a block 1310, a predetermined default message is associated with the update event. In one embodiment, the attorney updates case status information by selecting a case status from the case status code table illustrated in FIG. 21, and the “case status description” field illustrated in FIG. 21 corresponding to the selection is retrieved as the default message associated with the case status. In another embodiment, the case status code table in FIG. 21 includes an additional default message field for storing a more detailed description of each case status.

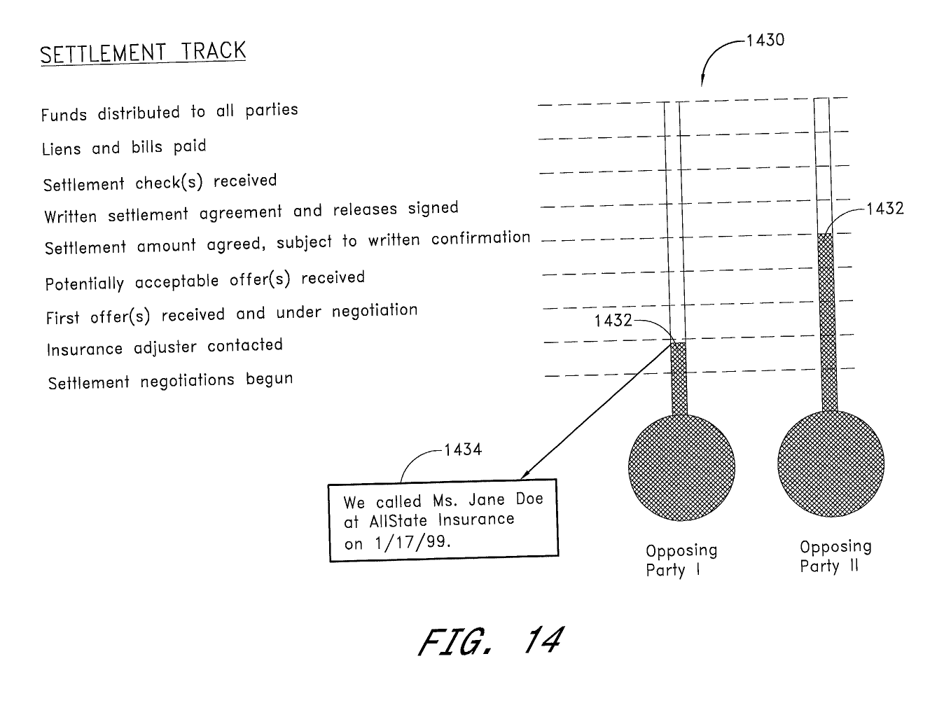

At a block 1312, the case status display is updated to reflect the status information change. In one embodiment, the mercury level of the thermometer as illustrated in FIG. 14 is relocated to reflect the status information change. In one embodiment, the post-retainer case page illustrated in FIG. 15 is updated—such as by updating data in case database fields corresponding to query tags in the page, and/or by displaying a message that an unread status update exists—to reflect the status information change. At a block 1314, a text message record is created using the custom message entered at block 1308 or the default message determined at block 1310, and is displayed on the post-retainer case page illustrated in FIG. 15. In another embodiment, a text message record is not created.

At a block 1316 of FIG. 13, an email message is automatically generated and sent to the client for notification of the update. In one embodiment, the email message contains the text message created at block 1314. In another embodiment, the email message informs the client that case status information has been changed and invites the client to click on a hyperlink to the post-retainer case page, without disclosing the details of the updated case status. The block 1316 proceeds to an end state at a block 1318.

FIG. 14 illustrates one embodiment of a case status display and update interface. In the embodiment illustrated by FIG. 14, a thermometer-style graphic effect 1430 is used. It will be appreciated by those of ordinary skill that another graphical object capable of representing progress or status, other than a thermometer-style graphic effect, may be used. The standard status listings from bottom (“Settlement negotiations begun”) to top (“Funds distributed to all parties”) represent the progression of case status. The mercury reading 1432 of the thermometer indicates the current status matching one of the standard status listings. In one embodiment, a text message 1434 is shown next to the mercury reading 1432 to further inform the client of the current status. The text message 1434 may be entered by the attorney, or may be a predetermined default message corresponding to a status.

In one embodiment, the thermometer may indicate a location between two neighboring standard status listings. In one embodiment, the retained attorney updates case status by using a mouse, a touch pen, a laser pen or voice command to drag the thermometer indicator to an appropriate height. In another embodiment, the retained attorney selects a status from a list of case statuses, or enters a numerical value representing a status, and the interface displays the thermometer indicator at a height corresponding to the status of the case.

In one embodiment, case status codes are classified into multiple tracks, for example a preliminary track, a settlement track, and a litigation track. A separate thermometer is displayed to represent progress on each track. In one embodiment, when there are multiple opposing parties, a separate thermometer is displayed for each opposing party in each track. FIG. 14 illustrate one example of a settlement track with two opposing parties, Opposing Party I and Opposing Party II. FIG. 15 illustrates thermometers for multiple tracks.

Case status information may also include trust account current balance, attorney's last update date, client last review date, hours the attorney has spent on the case, and so forth. In one embodiment, the attorney pays for expenses of the case for the client, and will be paid on a contingency fee basis. In that case, the trust account may be more accurately called a “case account” maintained by the attorney. Advantageously, when becoming a member of an ActiveLaw web site, an attorney agrees that his or her payments for the use of CaseSmart will not be passed on to the client. Thus, any balance shown in the case account excludes the attorney's expenses related to the use of CaseSmart.

FIG. 15 illustrates one example of a post-retainer case page. One section 1502 of the page displays case ID, last update dates and whether the viewing person has an unread text message. In one embodiment, CaseSmart determines the identity of the viewing person by the client ID or the attorney ID. CaseSmart then searches the text message table illustrated in FIG. 22 for unread text messages having a matching recipient ID. Another section 1504 of the page displays case information stored in the initial case table and the detailed case table. The client or the attorney may click on a hyperlink to view more details of case information on another page. A further section 1506 displays trust account balance and trust account entries, and another section 1508 allows the attorney or the client to enter text and search for text messages that contain the entered text. The section 1508 also displays action buttons that allow the attorney or the client to add a text message (i.e., post a message) and to change case information. In one embodiment, only the attorney is allowed to change case information, and CaseSmart may optionally impose time periods within which case information that has been recently entered may be changed, and after which the information may not be changed. The section 1508 also displays action buttons that allow the attorney to update case status, to add trust account entries, and to close the case.

A section 1510 displays case status for the preliminary track, the settlement track and the litigation track using thermometers. The thermometer display interface has been described above in connection with FIG. 14. It will be appreciated that another graphical object capable of showing progress or status may be used. Another section 1512 of FIG. 15 displays disclaimer messages.

A section 1514 displays text messages in chronological order, with a scroll bar to access earlier or later messages. In one embodiment, a text message record is automatically created for each case status information update, and displayed with the other messages in section 1514. A section 1516 displays links to other parts of the ActiveLaw™ web site, the link to log out, and miscellaneous messages.

FIG. 16 illustrates one example of an attorney profile table 1602. The “Field Name” column 1604 represents a partial list of fields that may be included in the attorney profile table. Fields with a “Yes” value in the “Key Field?” column 1606 represent fields that may be indexed to allow cross-referencing of other tables. Attorney profile fields such as “office location” and “state licensed” may also be indexed to facilitate speedy search by such fields. Fields with a “Yes” value in the “Accessible by Client?” column 1608 represent fields that may be displayed to clients.

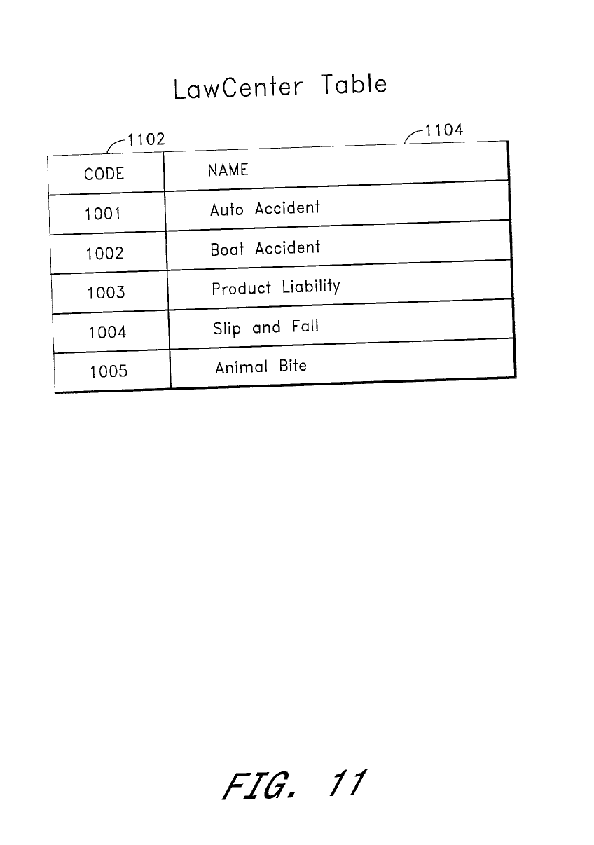

In one embodiment, CaseSmart permits the attorney to specify up to a predetermined number, such as, for example, four LawCenter codes, each typically representing those areas of practice in which he or she is most experienced. Each LawCenter code corresponds to a LawCenter, which is defined in a LawCenter table. FIG. 11 illustrates an example of a LawCenter table storing records having a code field 1102 and a name field 1104. The code field 1102 of each record preferably holds a numeric code value which is unique from record to record in the LawCenter table. Each record also has a corresponding alphanumeric name field describing a LawCenter. CaseSmart uses the LawCenter table to provide an interface by which the attorney can select among listed names of LawCenters (up to four of them for example), whereupon CaseSmart places the corresponding codes in LawCenter fields of attorney profile records.

In another embodiment, CaseSmart permits the attorney to enter any number, with or without limit, of LawCenters, only after receiving a representation from the attorney that, for each LawCenter, the attorney has a minimum experience threshold. In one embodiment the threshold requires that the attorney represent that he or she (1) has litigated or settled a minimum threshold number of cases (e.g., four) in the area of law corresponding to each of the entered LawCenters; and/or (2) has obtained settlements, verdicts or judgments totaling a minimum threshold dollar amount (e.g., $300,000) in the area of law corresponding to each of the entered LawCenters. The threshold number of cases or settlement, verdicts or judgments may differ from one LawCenter to another. CaseSmart may require the attorney's representation as to other experience thresholds as well.

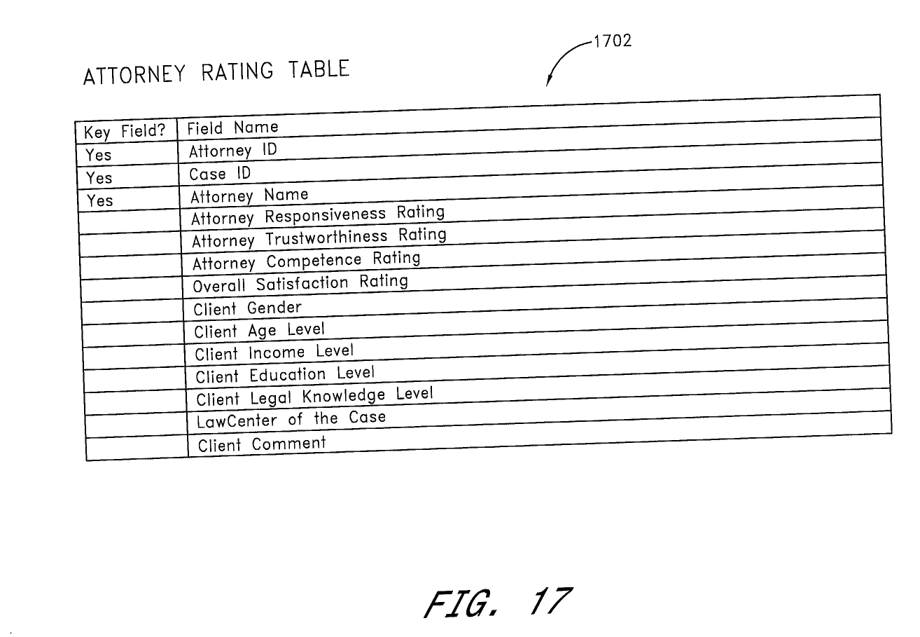

FIG. 17 illustrates one example of an attorney rating table 1702. In the illustrated embodiment, the attorney rating table includes the fields attorney ID, Case ID, attorney name, attorney responsiveness rating, attorney trustworthiness rating, attorney competence rating, overall satisfaction rating, client gender, client age level, client income level, client education level, client legal knowledge level, LawCenter of the case, and a client comment field. Those ordinarily skilled in the art will appreciate that the attorney profile table 1602 and the attorney rating table 1702 may alternatively be combined as one table. In one embodiment, rating information for each case is stored as one attorney rating record in the attorney profile database 112. In another embodiment, rating information for each case is stored as part of a detailed case record or part of a case status record, the aggregate rating information of all clients of an attorney is collected and stored as an attorney rating record in the attorney profile database 112.

FIG. 18 illustrates one example of an initial case table 1802. Fields of the illustrated embodiment include client name, case ID, client address, client email address, and client age. In one embodiment, the initial case table is stored in the case database 114. Those ordinarily skilled in the art will appreciate that the records in the case database 114 and the attorney profile database 112 may be integrated or separated into one or multiple databases.

FIG. 19 illustrates one example of a detailed case table 1902 and the fields thereof. In one embodiment, the detailed case table is stored in the case database 114. The initial case table and the detailed case table, as well as other tables described herein, may be cross-referenced, for example using a case ID, client ID and/or attorney ID. Those ordinarily skilled in the art will appreciate that the initial case table and the detailed case table may be combined as one table. In one embodiment, the search conditions and weight coefficients entered by the client are stored in the detailed case table. The candidate attorneys and the retained attorney may review such information to study the preferences of the client.

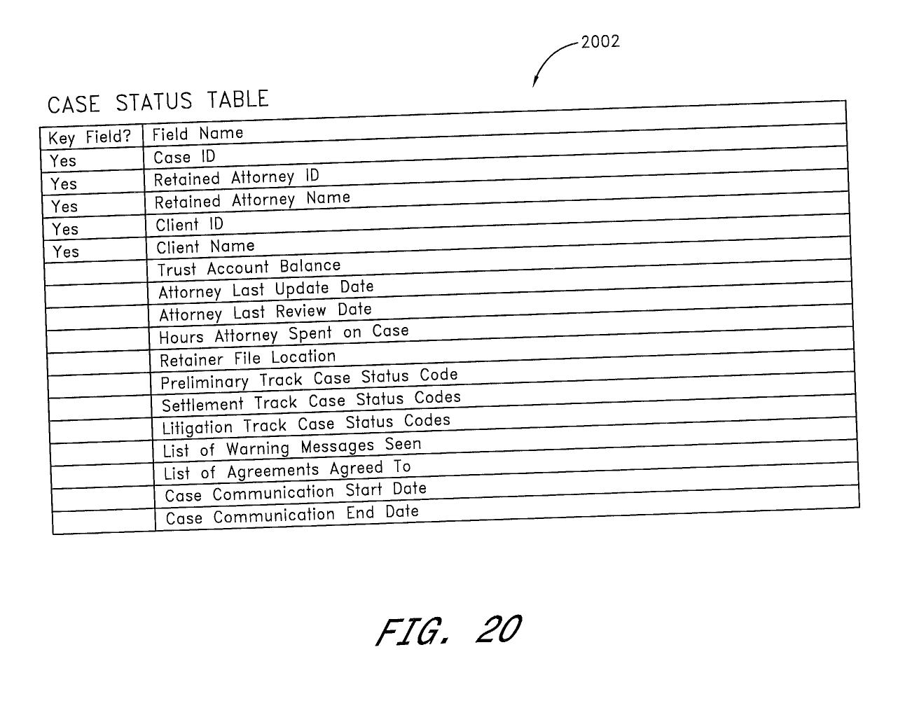

FIG. 20 illustrates one example of a case status table 2002 and the fields thereof. Trust account entries (such as additions to the account and deductions from the account) may also be stored in the case status table or another table. In one embodiment, the case status table stores a list of the warning messages the client has seen and a list of the agreements the client has entered. Warning messages may include warnings that the submitted case information becomes a permanent record of the client, that the client must submit case information truthfully, that a digital signature on a retainer agreement has legal effect, and so forth. Agreements may include statements that the client agrees to let an attorney or a third party verify the submitted case information, that the client agrees to let an attorney or a third party obtain personal records of the client, and so forth. The candidate attorneys and the retained attorney may review such information to know what type of warnings have been presented to the client and what agreements the client has made. In one embodiment, the “settlement track case status codes” and the “litigation track case status codes” may each contain multiple case status codes each relating to one of the opposing parties in the case.

FIG. 21 illustrates examples of records in a case status code table 2102. The case status codes in the case status code column 2104 correspond to the preliminary track, settlement track and litigation track case status codes in the case status table illustrated in FIG. 20. In one embodiment, an additional default message is associated with each status code. The default message is a more detailed description of the case status code than the “case status description” field. CaseSmart may show a default message to the client to represent a current status.

FIG. 22 illustrates one example of fields of a text message table 2202. For a given case, for either or both of the pre-retainer case page or the post-retainer case page, text messages may be retrieved by case ID 2204 and displayed in chronological order in accordance with the dates and times recorded in the date 2206 and time 2208 fields. Further, given any viewer, a client or an attorney, the messages authored by or sent to the viewer may be retrieved by matching the viewer's ID (client ID or attorney ID) to either or both of the author ID 2210 and Recipient ID 2212 fields.

In one embodiment illustrated in FIG. 15, the text messages for a case are displayed on the post-retainer case page. The text messages may also be displayed on the pre-retainer case page illustrated in FIG. 10. The author ID and the recipient ID correspond to the client ID and an attorney ID. In one embodiment, CaseSmart permits the retained attorney to view text messages between him or her and the client in the preretainer stage, but not text messages between the client and other candidate attorneys in the pre-retainer stage.

FIG. 23 illustrates one embodiment of an attorney's CaseSmart™ case control panel 2302. For each case record for which the attorney is the retained attorney or a candidate attorney, the panel displays a part of the case record. A case status 2304 of “potential new” means that the attorney has been selected as a candidate attorney but has not been retained. A case status 2304 of “open” means that the attorney has been retained and the case is in progress. A case status 2304 of “closed” represents that the case has reached a conclusion or the client and the attorney have agreed to terminate the case. The case control panel 2302 identifies the client name 2306 for each case. The case control panel 2302 also displays case ID 2308, number of days since last communication 2310, and also whether there are any unread messages associated with the case 2312.

In one embodiment, the panel may also provide a link 2314 to the pre-retainer case page (for “potentially new” cases) or post-retainer case page (for “open” or “closed” cases) associated with each case. By clicking on a link 2314 to the pre-retainer or post-retainer case page, the attorney enters the case page to view more comprehensive information of the case and to communicate with the client. A retained attorney may also update the status of the case on a post-retainer case page. In one embodiment, the pre-retainer case page is modified into the post-retainer case page for the same case. In one embodiment, if the attorney has only one case, then the attorney is shown the case page of that case, instead of the case control panel 2302.

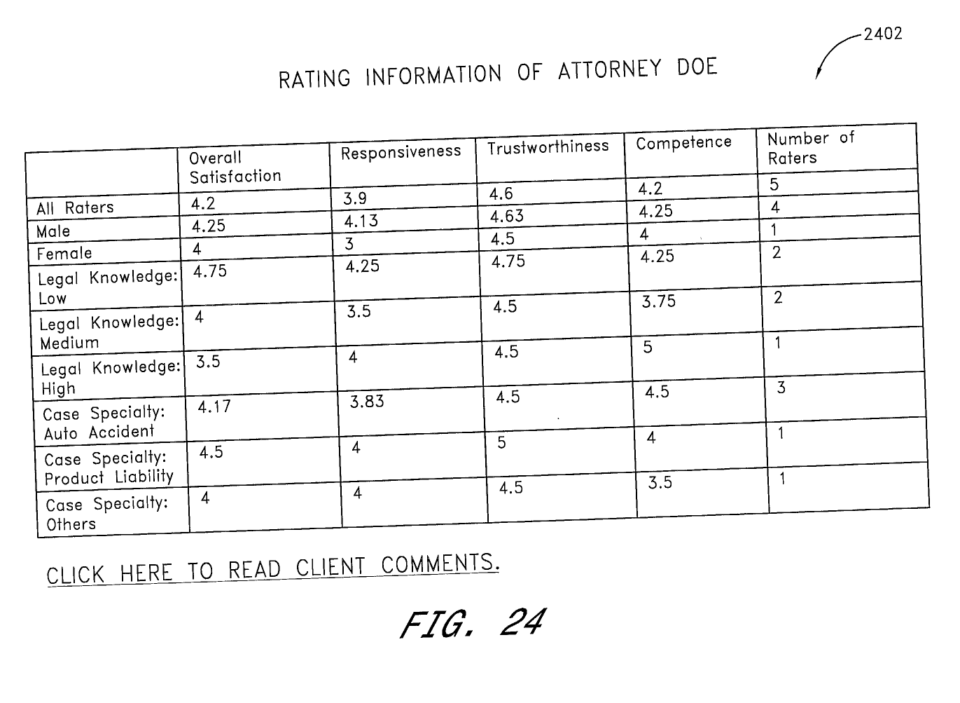

FIG. 24 illustrates one embodiment of entries in an attorney's rating information display 2402, as a part of an attorney's information page. The attorney's rating in each category is displayed as a numeric value between 1 and 5, with 5 being the highest score. In addition to an aggregate rating in overall satisfaction, responsiveness, trustworthiness and competence, FIG. 24 also breaks down ratings by client characteristics such as gender and legal knowledge level. FIG. 24 also breaks down ratings by case characteristics such as case LawCenter (practice sub-area). These classifications may help future clients locate an attorney with high ratings on a particular type of case or a particular type of client. FIG. 24 also provides a link from which viewers can read comments entered by raters. In one embodiment, a viewer must log in as a client before he or she can view the rating information of attorneys.

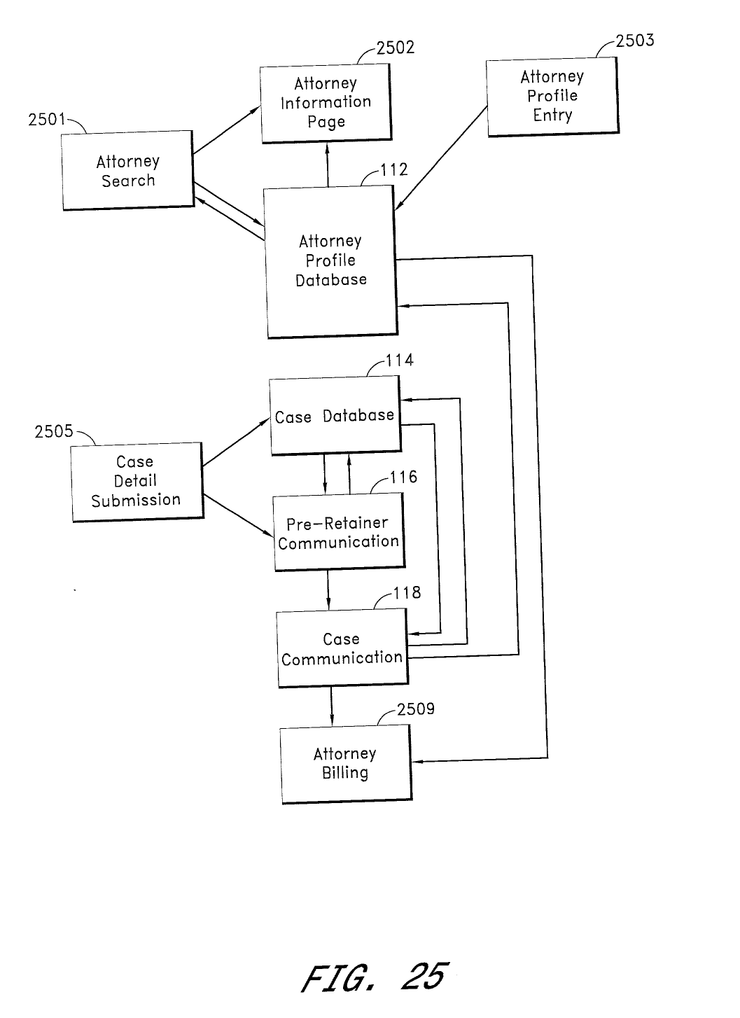

FIG. 25 illustrates components in accordance with an embodiment of the present invention for facilitating professional services rendered by an attorney to a client. The components represented in FIG. 25 comprise modules and features of an embodiment of CaseSmart.

Attorneys use an attorney profile entry module 2503 to enter profile information into the attorney profile database 112. An attorney information page module 2502 generates personal information web pages for the attorneys based on the profile information. The client uses an attorney search module 2501 to search for attorney profile information in the attorney profile database 112 that at least partially matches the client-entered search conditions. The attorney search module 2501 returns the search results to the client.

The client may view the attorney personal information pages displayed by the attorney information page module 2502 to learn more details about the attorneys disclosed in the search results. The client uses a case submission module 2505 to submit case information to candidate attorneys. The submitted case information is stored in a case database 114. The client and the candidate attorneys use a pre-retainer communication module 116 to discuss the case and the retainer agreement. After the client retains an attorney using the pre-retainer communication module 116, the client and the retained attorney use a case communication module 118 to discuss the case. The retained attorney uses the case communication module 118 to update the status of the case for the client to review. An attorney billing module 2509 bills the attorney for using the CaseSmart modules, including the case communication module. The attorney billing module 2509 bills the attorney using the billing information (such as credit card information and/or address information) stored in the attorney profile database. In one embodiment, the attorney billing module 2509 bills the attorney for entering profile information into the attorney profile database 112.

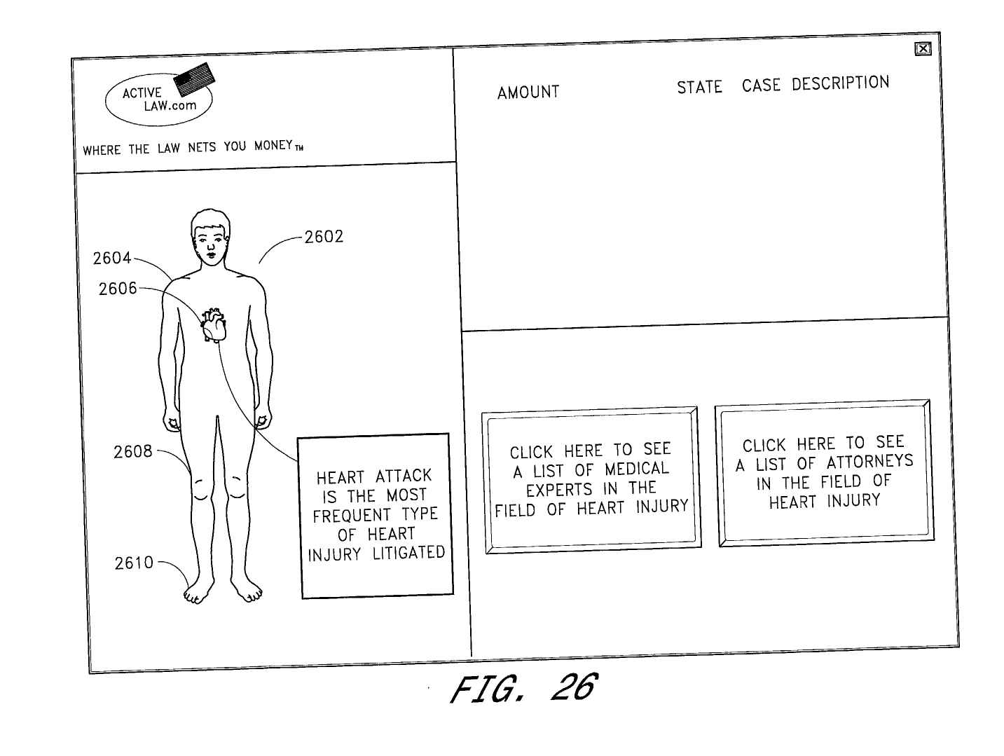

FIG. 26 illustrates one embodiment of a body part-related information display interface. The interface of FIG. 26 or a similar embodiment provides access to general information about service subject matter, for example, particular body parts.

A human form 2602 including multiple body parts (such as arm 2604, heart 2606, leg 2608 and foot 2610) is displayed on a web page of the ActiveLaw™ web site 202. By activating (such as clicking on a hyperlink or moving a cursor over) a body part, the user is presented information related to the activated body part. The information may include court decisions, medical information, news and law related to injury of the activated body part, medical experts in the field of injury of the activated body part, attorneys in the field of injury of the activated body part, and so forth. In one embodiment, activation of a body transmits a request for a web page related to the body part. The ActiveLaw™ web site receives the request and returns a web page to the user including information related to the body part.

In one embodiment, a body part table stores the address of each web page associated with each body part. In one embodiment, a web page specific to the activated body part is generated dynamically. More specifically, queries to be presented against the table are generated and presented, a returned recordset is parsed and scripted logic supplies formatting tags to the parsed results to complete a web page served to the user. The queries correspond to an activated body part and extract from the database only information corresponding to the activated body part. In one embodiment, a database administrator enters information into the database, providing a body part ID, and the queries generated by a request for a web page associated with a particular body part each use an associated body part ID. Those of ordinary skill in the art appreciate that a number of tools and techniques exist for generating web pages dynamically, including the association of logic scripts, such as CGI scripts, within template web pages, and also the use of tools such as Cold Fusion to associate database content with formatting and location within a web page. Approaches for dynamically generating web pages are described in U.S. Pat. Nos. 5,761,673, 5,894,554 and 5,983,227.

As used in the Specification, the word “module” refers not only to logic coded as a collection of software instructions, but also refers to logic embodied in hardware or firmware, or in semi-automated or manual processes. In the software context, a module may have entry and exit points and may be coded in a high level language such as C, C++, Java, SQL, or Pascal, or may be coded in machine or assembler language. Software modules may also be coded in an interpretive language, such as BASIC. Instructions of software modules may be coded with a text editor or a visual code development environment. Software modules may be compiled with a commercially available compiler and linked into an executable program, installed in a Dynamic Link Library (DLL) and/or loaded into firmware, such as an EPROM. Software modules may be callable from other modules, may be nested within other modules, and/or may be invoked in response to a detected event or interrupt. In the hardware context, modules may be comprised of connected logic units, such as gates and flip-flops, and/or may be comprised of programmable units, such as programmable gate arrays.

This invention may be embodied in other specific forms without departing from the essential characteristics as described herein. The embodiments described above are to be considered in all respects as illustrative only and not restrictive in any manner. The scope of the invention is indicated by the following claims and their equivalents rather than by the foregoing description.

What is claimed is:

1. A method of facilitating services, said method comprising:
generating listing information identifying a service provider;
making said listing information available to potential clients of said service provider; and
receiving an agreement from said service provider to use a first service-enhancing system to provide services to each client obtained as a result of said making said listing information available.

2. The method of claim 1, further comprising:
generating second listing information identifying a second service provider;
receiving an agreement from said second service provider to use a second service-enhancing system having at least one feature absent from said first service-enhancing system;
making said second listing information available to at least some of said potential clients; and
enhancing the availability to said at least some potential clients of said second listing information.

3. A method of facilitating services, said method comprising:
generating listing information identifying a service provider;
making said listing information available to potential clients of said service provider; and
receiving an agreement from said service provider to adhere to certain standards of care in providing services to each client obtained as a result of said making said listing information available, said certain standards being more specific, or higher, than those generally accepted or legally required to practice in the industry of said service provider.

4. The method of claim 3, further comprising:
receiving an agreement from said service provider to use a computer software-based process to assure that said service provider adheres to said certain standards of care.

5. The method of claim 4, further comprising:
receiving a payment from said service provider for using said computer software-based process.

6. The method of claim 5, further comprising:
receiving an agreement from said service provider not to pass on to any client any cost of using said computer software-based process.

7. A method of facilitating services, said method comprising:
providing in a profile database profile data representing characteristics of a plurality of service providers, said profile data including identification data identifying each of said plurality of service providers;
receiving profile criteria and responsively searching said profile data for said profile criteria;
determining a portion of said profile data representing characteristics of a first of said plurality of service providers at least approximately match at least a portion of said profile criteria;
automatically generating a candidate selection prompt for a client to select said first service provider as a candidate for providing services to said client, said candidate selection prompt communicating a representation of said identification data identifying said first service provider;
receiving service summary information summarizing needed services and making said service summary information available to said first service provider;
automatically generating a prompt for said first service provider to agree to provide said needed services to said client;
providing a computer-based service module for use in providing services to said client or reporting the status of said services, said computer-based service module accessible by said client and said first service provider; and
receiving a payment from said first service provider.

8. The method of claim 7, wherein said first service provider is an attorney.

9. The method of claim 7, wherein said payment is for use of said computer-based service module.

10. The method of claim 7, wherein said computer-based service module automatically enforces certain standards that are more specific, or higher, than those generally accepted or legally required to practice in the industry of said first service provider.

11. The method of claim 7, further comprising:
receiving acknowledgment data from said client, said acknowledgement data representing said client's understanding of (1) rules for using said computer-based service module, (2) consequences of untruthful or misleading information provided by said client, or (3) information provided by said client becoming a permanent part of a record of services, wherein said service summary information is made available to said first service provider only after said receiving of said acknowledgement.

12. The method of claim 7, further comprising:
receiving from said first service provider a password and responsively making available to said first service provider said service summary information and second service summary information summarizing second services needed.

13. The method of claim 12, wherein said second services are needed by a second client.

14. The method of claim 12, wherein said service summary information and said second service summary information are accessible from a single web page.

15. The method of claim 7, wherein said matched portion of said profile criteria includes data representing foreign language skills.

16. The method of claim 7, wherein said matched portion of said profile criteria includes data representing an area serviced by said first service provider.

17. The method of claim 7, wherein said matched portion of said profile criteria includes data representing experience of said first service provider.

18. The method of claim 7, wherein said computer-based service module facilitates and stores communications between said first service provider and said client.

19. The method of claim 7, wherein said profile criteria include first and second profile criteria, the method further comprising:
assigning a first weight to said first profile criteria; and
assigning a second weight to said second profile criteria, said step of said determining performed by a computer after respectively applying said first and second weights to said first and second profile criteria.

20. The method of claim 7, wherein said matched portion of said profile criteria includes data representing a keyword provided by said client.

21. The method of claim 7, further comprising:
communicating in said candidate selection prompt a representation of no more than a predetermined maximum number of service providers having associated profile data at least partially matching said profile criteria.

22. The method of claim 7, further comprising:
communicating in said candidate selection prompt a representation of no less than a predetermined minimum number of service providers having associated profile data at least partially matching said profile criteria.

23. The method of claim 7, wherein said profile criteria represent a geographic area, said method further comprising:
communicating in said candidate selection prompt a representation of a first set of service providers for which a portion of said profile data represents a first area corresponding to said geographic area; and
communicating in said candidate selection prompt a representation of a second set of service providers for which a portion of said profile data represents a second area, said second area within a predetermined maximum distance from said first area.

24. The method of claim 7, further comprising:
providing over a network an electronic submission form having fields relevant to the needed services;
receiving said electronic submission form over said network; and
parsing data identifying said fields to extract data representing said service summary information;

25. The method of claim 7, further comprising:
notifying said first service provider that said client wants to consider hiring said first service provider.

26. The method of claim 25, wherein said notifying comprises automatically generating an email message to an email address of said first service provider, said email address represented in said profile data.

27. The method of claim 25, wherein said notifying comprises automatically generating a telephone call to a telephone number of said first service provider, said telephone number represented in said profile data.

28. The method of claim 26, further comprising:
generating a computer displayable representation of said service summary information accessible with a hyperlink, wherein said automatically generated email message includes said hyperlink;

29. The method of claim 24, further comprising:
prompting said first service provider to review said service summary information; and
prompting said first service provider to post a message to said client.

30. The method of claim 29, further comprising:
notifying said client that a message has been posted; and
prompting said client to review said posted message.

31. The method of claim 29, further comprising:
notifying said first service provider that a communication has been posted for said first service provider; and
prompting said first service provider to review said posted communication.

32. The method of claim 25, further comprising:
receiving a client password prior to said notifying of said first service provider.

33. The method of claim 29, further comprising:
receiving a first service provider password prior to prompting said first service provider to review said service summary information.

34. The method of claim 7, further comprising:
making available to said client a retainer agreement from said first service provider.

35. The method of claim 7, further comprising:
receiving or sending retainer negotiation messages to or from said client or said first service provider.

36. The method of claim 34, further comprising:
receiving a digital signature of said retainer agreement from said client.

37. The method of claim 34, further comprising:
billing said first service provider automatically upon execution of said retainer agreement.

38. The method of claim 37, further comprising:
automatically stopping billing of said first service provider when said first service provider completes rendering of said needed services.

39. The method of claim 34, further comprising:
verifying that said client has not signed a different retainer agreement since a predetermined date.

40. The method of claim 39, wherein said predetermined date is one year earlier than a current date.

41. The method of claim 7, further comprising:
receiving candidate selection data from said client in response to said candidate selection prompt, said candidate selection data identifying said first service provider and a second service provider; and
making available to said client via said computer-based service module (1) question or comment messages from said first or second service providers, (2) negotiation messages from said first or second service providers, or (3) retainer agreements from said first or second service providers.

42. The method of claim 7, further comprising:
receiving via said computer-based service module status information representing a status of services rendered; and
making available to said client via said computer-based service module said status information.

43. The method of claim 42, further comprising:
receiving via said computer-based service module case information from said client, said case information descriptive of or pertinent to said services rendered;
storing said status information and said case information in computer-readable media; and
making available via said computer-based service module said status information and said case information during the rendering of said services and for a predetermined time period following the rendering of said services.

44. The method of claim 43, further comprising:
storing said status information and said case information in a permanent medium.

45. The method of claim 42, wherein said computer-based service module prevents said first service provider from changing said status information after a fixed expiration period.

46. The method of claim 42, wherein said computer-based service module prevents said client from changing said status information.

47. The method of claim 42, wherein said case status information comprises:
case accounting data representing costs associated with the services provided by said first service provider.

48. The method of claim 42, wherein said status information comprises:
a services progress display representing actions said first service provider has taken on behalf of said client.

49. The method of claim 48, wherein said services progress display is in the form of a graphically represented meter, said meter having multiple gradation indicators, each of said multiple gradation indicators corresponding to one of a set of actions that have been or may be taken by said first service provider, said meter having a current reading indicator corresponding to an action most recently taken by said first service provider.

50. The method of claim 10, wherein said certain standards include a minimum frequency of communicating to said client.

51. The method of claim 7, further comprising:
prompting said client to enter rating information about said first service provider.

52. The method of claim 7 represented by instructions executable by a computer, said instructions stored on a computer-readable medium.

53. Status data representing past and current statuses of services rendered by a service provider, said status data comprising:
historic status data representing at least one non-current status of services rendered by a service provider, said historic status data accessible by a computer for read only viewing; and
current status data representing a current status of said services rendered by said service provider, said current status data accessible by a computer for read only viewing and accessible for a predetermined time for modification by said service provider, said predetermined time shorter than the time remaining to complete the rendering of said services.

54. Status data representing past and current statuses of services rendered by a service provider, said status data comprising:
historic service data descriptive of services rendered or to be rendered by a service provider, said historic service data accessible by a computer for read only viewing; and
current service data descriptive of services rendered or to be rendered by said service provider, said current service data more recent than said historic service data, said current service data accessible by a computer for read only viewing and accessible for a predetermined time for modification by a client of said service provider, said predetermined time shorter than the time remaining to complete the rendering of said services.

55. A service system facilitating the rendering of services, comprising:
profile data representing characteristics of a plurality of service providers, said profile data stored on a first computer-readable medium;
a search engine responsive to search criteria to search said profile data for portions of said profile data at least approximately matching said search criteria and to generate result data identifying service providers corresponding to said at least approximately matched portions of said profile data, said result data formatted for presentation, said search engine comprising instructions executable by a processor;
a communication module making available to a client said result data, said communication module receiving candidate data representing a candidate set of service providers comprising one or more of said service providers identified by said result data, said communication module receiving and storing said service summary data representing needed services and making said service summary data available to each of said candidate set of service providers;
a case communication module receiving status data from a selected service provider selected from said candidate set of service providers, said status data representing a status of services provided by said selected service provider, said case communication module storing said status data and making said status data available to said client; and
a billing module generating a request for payment from said selected service provider.

56. The service system as described in claim 55, wherein said payment is for use of said case communication module.

57. The service system as described in claim 55, wherein said search criteria include first and second profile criteria, the service system further comprising:
a first importance level assigned to said first profile criteria; and
a second importance level assigned to said second profile criteria, said search engine configured to adjust said result data in accordance with said first and second importance levels.

58. The service system as described in claim 57, wherein said adjusted result data represent an ordered list of service providers, wherein a group of at least one of said service providers is represented at the front of said list, and wherein portions of said profile data representing characteristics of each of said at least one service providers in said group matches said first profile criteria.

59. The service system as described in claim 55, wherein said profile data include data representing service provider experience.

60. The service system as described in claim 55, wherein said profile data include data representing an area serviced.

61. The service system as described in claim 55, wherein said profile data include data representing foreign language skills.

62. The service system as described in claim 57, wherein said first profile criteria include data representing experience, and said second profile criteria include data representing an area serviced.

63. The service system as described in claim 57, wherein said first importance level and said second importance level represent different levels of importance.

64. The service system as described in claim 55, wherein said case communication module enforces certain standards that are more specific, or higher, than those generally accepted or legally required to practice in the industry of said service provider.

65. A computer-based services system, comprising:
a message archive storing on a first computer-readable medium message timing data representing a date and a time of at least one message sent from a service provider to a client or from a client to a service provider;
an update timer comprising instructions stored on a second computer-readable medium, said instructions executable by a processor to access said message timing data to determine a latest message time corresponding to the most recent of said at least one messages and to calculate a response time by comparing said latest message time and a current time; and
a message generator automatically generating a warning message when said response time is greater than a predetermined response time.

66. The computer-based services system as described in claim 65, wherein said message generator automatically generates said warning message when fewer than a predetermined number of said at least one messages are dated later than a cut-off date, said cut-off date earlier than a current date by a predetermined number of days.

67. The computer-based services system as described in claim 65, wherein said predetermined response time is shorter than a maximum non-communication time representing a duration of non-communication between clients and service providers in the industry of said service providers longer than is generally accepted in said industry.

68. The computer-based services system as described in claim 65, wherein said predetermined response time is one month.

69. The computer-based services system as described in claim 65, further comprising:
an override time representing a period of time during which said message generator does not generate said warning message when said response time is greater than said predetermined response time.

70. The computer-based services system as described in claim 69, further comprising:
confirmation data stored on said first computer-readable medium, said confirmation data representing an agreement by a client that said service provider need provide no communication or status update during said override time.

71. The computer-based services system as described in claim 65, further comprising:
status update data stored in said message archive, said status update data representing at least one status update to inform said client about the status of services provided by said service provider, said message timing data representing a date and time of each of said at least one status update; and
a communication module responsive to a user request and to a change signal to permit said service provider to change a status update, said change signal generated by said update timer if a difference between a current time and a date and time associated with said status update is less than a predetermined change period.

72. The computer-based services system as described in claim 71, wherein said predetermined change period is twenty-four hours.

73. The computer-based services system as described in claim 65, further comprising:
a communication module responsive to a user request and to a change signal to permit said client to change selected data in said message archive, said change signal generated by said update timer if a difference between a current time and a time associated with said selected data is less than a predetermined change period.

74. A system for facilitating services, said system comprising:
means for representing with computer-readable data characteristics of and identification of a service provider;
means for allowing potential clients to search said characteristics over a computer network and receive a representation of data identifying said service provider; and
means for receiving agreement from said service provider to use a communication-enhancing system to provide services to each client obtained via said means for allowing potential clients to search said characteristics.

75. A system for facilitating services, said system comprising:
means for representing with computer-readable data characteristics of and identification of a service provider;
means for allowing potential clients to search said characteristics over a computer network and receive a representation of data identifying said service provider; and
means for receiving a representation from said service provider that said service provider meets certain minimum experience requirements, said experience requirements being more specific, or higher, than those generally accepted or legally required to practice in the industry of said service provider.

76. A method of facilitating services, said method comprising:
a step for providing in a profile database profile data representing characteristics of a plurality of service providers, said profile data including identification data identifying each of said plurality of service providers;
a step for using profile criteria to search said profile data and at least approximately match at least a portion of said profile criteria to characteristics of a first of said plurality of service providers;
a step for communicating an intent of said client to hire said service provider to provide services to said client;
a step for providing a computer network-based service module for use in providing said services to said client or reporting the status of said services, said computer network-based service module accessible by said client and said service provider; and
a step for receiving an agreement from said service provider to use said computer-based service module in providing services to said client.

77. The method of claim 76, said method further comprising:
a step for providing an interface for communicating basic information to said client relating to said services, said interface comprising a graphic representation of an object relating to said services, regions of said graphic representation relating to corresponding parts of said object, said regions independently selectable to retrieve and present information to said client relating to said corresponding parts of said object.

78. The method of claim 77, wherein said object is a human body, wherein said regions correspond to parts of said human body, wherein said regions are selectable to present information to said client about body part injuries or operations, and wherein said services relate to legal or medical industries.
